(19) United States
(12) Patent Application Publication
(10) Pub. No.: US 2005/0254085 A1
(43) Pub. Date: Nov. 17, 2005

(54) Image forming system

(76) Inventors: Koji Oshikiri, Miyagi (JP); Yasuyuki Shindoh, Miyagi (JP); Junichi Ikeda, Miyagi (JP); Koji Takeo, Miyagi (JP); Noriyuki Terao, Miyagi (JP); Atsuhiro Oizumi, Miyagi (JP); Yutaka Maita, Miyagi (JP); Satoru Numakura, Miyagi (JP); Tohru Sasaki, Iwate (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/121,060

(22) Filed: May 4, 2005

(30) Foreign Application Priority Data
May 12, 2004 (JP) 2004-142084
Nov. 9, 2004 (JP) 2004-324554

(51) Int. Cl. G06F 15/00; G09G 5/02

(52) U.S. Cl. 358/1.15

(57) ABSTRACT

An image forming system comprising a serial communication control part, an image input part, an image output part, an image processing part, a storage part, a printer controller, and a high-speed serial bus. The high-speed serial bus mutually couples the serial communication control part and at least one of the image input part, the image output part, the image processing part, the storage part and the printer controller.

### BACKGROUND OF THE INVENTION

1. Field of the Invention

The present invention generally relates to, and more particularly to image forming systems, and more particularly to an image forming system such as a composite apparatus and a Multi Function Peripheral (or Processor) (MFP) that treat various kinds of image data and carry out various kinds of processes.

2. Description of the Related Art

A Japanese Laid-Open Patent Application No.2000-151878 proposes an architecture for a digital copying apparatus in which a plotter, a scanner and a user interface are connected to a processor via a standard bus such as a Peripheral Component Interconnect (PCI) bus.

A Japanese Laid-Open Patent Application No.2001-016382 proposes a system structure for a digital copying apparatus provided with a scanner control part, a write control part and a main control part, in which a high-speed serial interface such as an IEEE1394 bus and a Universal Serial Bus (USB) is used as an internal interface.

As other high-speed serial interfaces, an interface called the PCI Express (Registered Trademark), which corresponds to a standard that is to succeed the PCI bus system, is proposed in Shoji Satomi, “Summary of PCI Express Standard”, Interface Magazine, pp.80-93, July 2003 and is reaching a stage ready for reduction to practice.

Recently, image forming systems (or image forming apparatuses) such as digital copying apparatuses and MFPs which treat image data and other data are used in various fields. With respect to these image forming systems, there are demands to further improve the high-speed operation, high performance, multiple functions and extensibility.

The conventional digital image forming system is designed to realize functions that are necessary for processing a large amount of data by a simple structure. Under this design concept, it is possible to design an inexpensive image forming system, but on the other hand, it is difficult to modify or expand the image forming system in a simple manner, thereby making the extensibility of the image forming system relatively poor. For example, a large portion of the circuits forming the image forming system is mounted on a single circuit board, and a processing control mechanism is formed essentially by a single unit. In order to further improve the high-speed operation, high performance and multiple functions of the image forming system having such a structure, it becomes necessary to replace the entire circuit board or to modify the design of the circuit board every time a modification is made, even if the modification only relates to a portion of the circuits. Consequently, the developing cost and the developing time of the modified image forming system increase, to thereby deteriorate the extensibility of the image forming system.

As a new approach to design the copying apparatus, it is possible to employ an architecture that uses a PCI bus, similarly as in the case of the architecture of the computer system such as personal computers, as proposed in the Japanese Laid-Open Patent Application No.2000-151878, for example. In this case, the PCI bus connects a controller and a function part such as an image processing part and an image recording part. In the case of the Japanese Laid-Open Patent Application No.2000-151878, a main part that is formed by a processor and a memory is connected to the various function parts (or modules) forming the copying apparatus via the PCI bus.

By using the PCI bus, it is possible to exchange control data, image data and the like on the PCI bus bidirectionally. In addition, the function modules can be modified or added with ease. Hence, it may be regarded that the use of the PCI bus facilitates the further improvement of the high-speed operation, high performance and multiple functions of the image forming system.

However, the PCI bus transfers the control data, the image data and the like in parallel, which consequently increases both the number of wirings and the cost of the interface. Moreover, the individual function modules that use the PCI bus must be concentrated and arranged at a single location on a mother board on which the processor, the memory and the like are mounted. As a result, the degree of layout freedom on the mother board is limited, and it is difficult to flexibly cope with the multiple functions.

Furthermore, when transferring the data in parallel, data error and inconsistency are generated among the signal lines, and the crosstalk phenomenon occurs in which the signal lines mutually affect voltages thereof. Accordingly, the PCI bus is unsuited for high-speed data transfer, and it is difficult to satisfy the demands of the high-speed operation when using the PCI bus. In other words, according to the PCI bus employing the parallel system, problems such as racing and skew are generated, and the transfer rate that is obtainable is now becoming too low for use in the image forming system which must further improve the high-speed operation and high image quality.

In addition, when a plurality of modules are connected by the PCI bus, it is necessary to share a single PCI bus by allocating input and output addresses and Interrupt Requests (IRQs) so as not to generate contention with other modules. That is, the data transfer must be made time-divisionally between the modules, and it is difficult to realize a high-speed data transfer.

On the other hand, the Japanese Laid-Open Patent Application No.2001-016382 enables the design of the digital copying apparatus with a large degree of freedom by using the high-speed serial interface, such as the IEEE1394 and the USB, as the internal interface. In this digital copying apparatus, a laser write (or diode) control unit (LDU) that controls a write laser for writing an image on a photoconductive body, a scanner control unit (SCU) that controls the scanner, and a panel control unit (PCU) that controls an operation panel used by the user for inputting operating instructions are connected to a mother board (MBD) that controls the entire digital copying apparatus via the high-speed serial interface, directly by a serial cable.

However, since there are demands to further improve the high-speed operation and the high image quality, it is becoming more difficult to carry out the data transfer at a sufficiently high speed that is demanded by employing the structure proposed in the Japanese Laid-Open Patent Application No.2001-016382 using the general-purpose bus such as the IEEE1394 and, the USB. In addition, it is becoming more difficult to secure the desired extensibility of the digital copying apparatus due to electrical and physical restrictions on the hardware. Moreover, when measures are taken to secure the high-speed data transfer and the extensibility, the bus width increases to generate problems such as difficulty in designing the circuit board, increase in the cost of the circuit board, increase in the cost of the digital copying apparatus due to increased number of ASIC pins, and the like.

The Japanese Laid-Open Patent Application No.2001-016382 does not mention the problems encountered when simultaneously transferring a plurality of image data. In addition, although a plurality of traffics are generated since the digital copying apparatus has the serial structure and has the large degree of freedom of design, the Japanese Laid-Open Patent Application No.2001-016382 does not mention the effects of timing restrictions and the like with respect to the line synchronous transfer.

On the other hand, as other high-speed serial interfaces, the interface called the PCI Express (Registered Trademark), which corresponds to the standard that is to succeed the PCI bus system, is proposed in Shoji Satomi, “Summary of PCI Express Standard”, Interface Magazine, pp.80-93, July 2003 and is reaching the stage ready for reduction to practice, as described above.

### SUMMARY OF THE INVENTION

Accordingly, it is a general object of the present invention to provide a novel and useful image forming system in which the problems described above are suppressed.

Another and more specific object of the present invention is to provide an image forming system which can further improve the high-speed operation and the extensibility, by applying an interface technology such as the PCI Express to the image forming system.

Still another and more specific object of the present invention is to provide an image forming system which enables a high-speed image data output and simultaneous transfer, even when timing restrictions of the line synchronous transfer exist, by effectively utilizing a high-speed serial bus such as the PCI express standard that realizes a high scalability.

A further object of the present invention is to provide an image forming system comprising a serial communication control part, an image input part, an image output part, an image processing part, a storage part and a printer controller; and a high-speed serial bus mutually coupling the serial communication control part and at least one of the image input part, the image output part, the image processing part, the storage part and the printer controller. According to the image forming system of the present invention, it is possible to further improve the high-speed operation and the extensibility, by applying an interface technology such as the PCI Express to the image forming system. Further, by transferring image data in synchronism with a line synchronizing signal via the high-speed serial bus, it is possible to realize a high-speed image data output and simultaneous transfer, even when timing restrictions of the line synchronous transfer exist, by effectively utilizing a high-speed serial bus such as the PCI express standard that realizes a high scalability.

Other objects and further features of the present invention will be apparent from the following detailed description when read in conjunction with the accompanying drawings.

### BRIEF DESCRIPTION OF THE DRAWINGS

FIG. 1 is a system block diagram showing a structure of an existing PCI system;

FIG. 2 is a system block diagram showing a structure of a PCI Express system;

FIG. 3 is a system block diagram showing a structure of a PCI Express platform applied to a desk-top or mobile system;

FIG. 4 is a diagram schematically showing a structure of physical layers for x4 links;

FIG. 5 is a diagram schematically showing lanes connecting devices;

FIG. 6 is a system block diagram showing a logical structure of a switch;

FIGS. 7A and 7B are system block diagrams respectively showing an existing PCI architecture and a PCI Express architecture;

FIG. 8 is a system block diagram showing the PCI Express hierarchical structure;

FIG. 9 is a diagram for explaining a format of a Transaction Layer Packet (TLP);

FIG. 10 is a diagram for explaining a configuration space of the PCI Express;

FIG. 11 is a diagram for schematically explaining the concept of a virtual channel;

FIG. 12 is a diagram for explaining a format of a Data Link Layer Packet (DLLP);

FIG. 13 is a diagram schematically showing a byte striping for x4 links;

FIG. 14 is a time chart for explaining a control of an active state power supply management;

FIG. 15 is a system block diagram generally showing an embodiment of an image forming system according to the present invention;

FIG. 16 is a system block diagram generally showing a first modification of the embodiment of the image forming system according to the present invention;

FIG. 17 is a system block diagram generally showing a second modification of the embodiment of the image forming system according to the present invention;

FIG. 18 is a system block diagram generally showing a third modification of the embodiment of the image forming system according to the present invention;

FIG. 19 is a system block diagram generally showing a fourth modification of the embodiment of the image forming system according to the present invention;

FIG. 20 is a system block diagram generally showing a fifth modification of the embodiment of the image forming system according to the present invention;

FIG. 21 is a system block diagram generally showing a sixth modification of the embodiment of the image forming system according to the present invention;

FIG. 22 is a system block diagram generally showing a seventh modification of the embodiment of the image forming system according to the present invention;

FIG. 23 is a system block diagram generally showing an eighth modification of the embodiment of the image forming system according to the present invention;

FIG. 24 is a system block diagram generally showing a ninth modification of the embodiment of the image forming system according to the present invention;

FIG. 25 is a system block diagram generally showing a tenth modification of the embodiment of the image forming system according to the present invention;

FIG. 26 is a system block diagram generally showing an eleventh modification of the embodiment of the image forming system according to the present invention;

FIG. 27 is a system block diagram showing a second embodiment of the image forming system according to the present invention;

FIG. 28 is a system block diagram generally showing a structure of the image forming system;

FIGS. 29A and 29B are timing charts schematically showing a command issuing sequence;

FIG. 30 is a diagram generally showing a mechanism of the data transfer system;

FIGS. 31A through 31C are diagrams showing an arbitration characteristic;

FIG. 32 is a diagram showing a basic characteristic of a payload;

FIG. 33 is a system block diagram generally showing a structure of the image forming system having a plurality of serial communication control parts in a state before a link-up; and

FIG. 34 is a system block diagram generally showing a structure of the image forming system shown in FIG. 33 in a state after the link-up.

### DESCRIPTION OF THE PREFERRED EMBODIMENTS

A description will be given of embodiments of an image forming system according to the present invention, by referring to the drawings.

### Summary of PCI Express Standard

An embodiment of the image forming system according to the present invention utilizes the PCI Express (registered trademark) which is a high-speed serial bus. A summary of the PCI Express standard which is used as a precondition in this embodiment, will first be described based on an excerpt from Shoji Satomi, “Summary of PCI Express Standard”, Interface Magazine, pp.80-93, July 2003. In the following description, a high-speed serial bus refers to an interface which can exchange data at a high speed of 100 Mbps or higher by a serial transmission using a single transmission path.

The PCI Express, which corresponds to the standard that is to succeed the PCI bus system, is a bus that is standardized as a standard extension bus to be applied to computers in general. Generally, the PCI Express has features such as low voltage differential signal transmission, communication channels that are independent for transmission and reception and point-to-point, packetized split transaction, and high scalability due to different link structures.

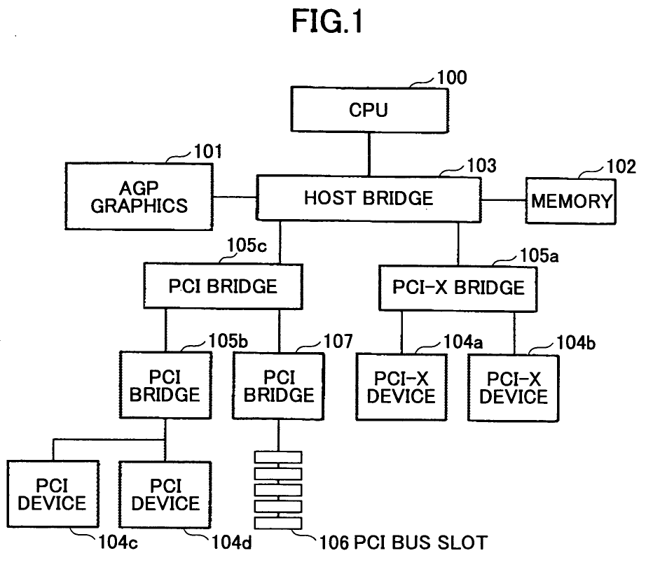

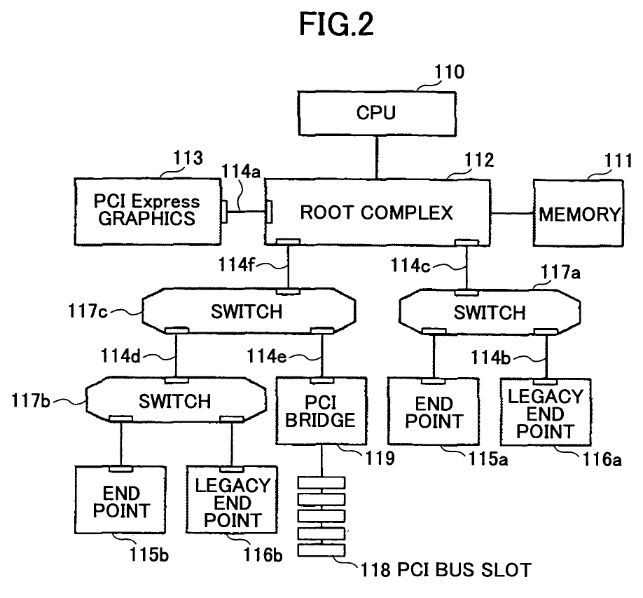

FIG. 1 is a system block diagram showing a structure of an existing PCI system, and FIG. 2 is a system block diagram showing a structure of a PCI Express system.

In the existing PCI system shown in FIG. 1, a CPU 100, an AGP graphics 101 and a memory 102 are connected to a host bridge 103. PCI-X (host compatible standard of PCI) devices 103a and 104b are connected to the host bridge 103 via a PCI-X bridge 105a, PCI bridges 105b and 107 are connected to the host bridge 103 via the PCI bridge 105c, PCI devices 104c and 104d are connected to the PCI bridge 105b, and a PCI bus slot 106 is connected to the PCI bridge 107, so as to form a tree structure.

On the other hand, in the PCI Express system shown in FIG. 2, a CPU 110 and a memory 111 are connected to a root complex 112, and a PCI Express graphics 113 is connected to the root complex 112 via a PCI Express 114a. An end point 115a and a legacy end point are connected to a switch 117a via a PCI Express 114b, and the switch 117a is connected to the root complex 112 via a PCI Express 114c. An end point 115b and a legacy end point 116b are connected to a switch 117b, and the switch 117b is connected to the switch 117c via a PCI Express 114d. A PCI bus slot 118 is connected to a PCI bridge 119, and the PCI bridge 119 is connected to a switch 117c via a PCI Express 114e. The switch 117c is connected to the root complex 112 via a PCI Express 114f. Hence, the PCI Express system has a tree structure having such connections.

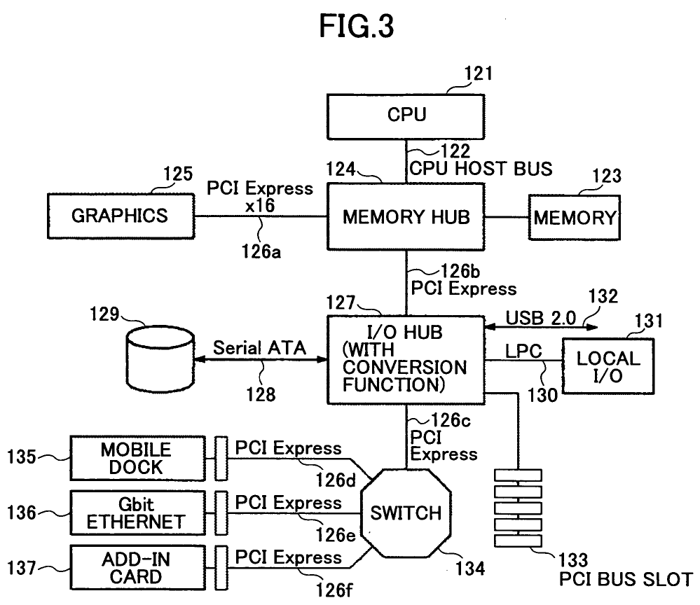

A PCI Express platform that is actually supposed is shown in FIG. 3. FIG. 3 is a system block diagram showing a structure of a PCI Express platform applied to a desk-top or mobile system. In FIG. 3, a CPU 121 is connected to a memory hub 124 which corresponds to the root complex, via a CPU host bus 122. A memory 123 is connected to the memory hub 124. For example, a graphics 125 is connected to the memory hub 124 via a x16 PCI Express 126a. An input and output (I/O) hub 127 having a conversion function is connected to the memory hub 124 via a PCI Express 126b. For example, a storage 129 is connected to the I/O hub 127 via a Serial ATA 128. A local input and output (I/O) device 131 is connected to the I/O hub 127 via an LPC 130. An USB2.0 132 and a PCI bus slot 133 are also connected to the I/O hub 127. Further, a switch 134 is connected to the I/O hub 127 via a PCI Express 126c. A mobile dock 135, a Gbit Ethernet (registered trademark) 136 and an add-in card 137 are connected to the switch 134 via corresponding PCI Expresses 126d, 126e and 126f.

In other words, in the PCI Express system, the conventional buses such as the PCI, PCI-X and AGP are replaced by the PCI Express, and the bridge is used to connect the existing PCI or PCI-X devices. The PCI Express connection is also used for the connection of chip sets, and the existing buses such as the IEEE1394, Serial ATA and USB 2.0 are connected to the PCI Express using the I/O hub.

### Structural Elements of PCI Express

A. Port, Lane & Link:

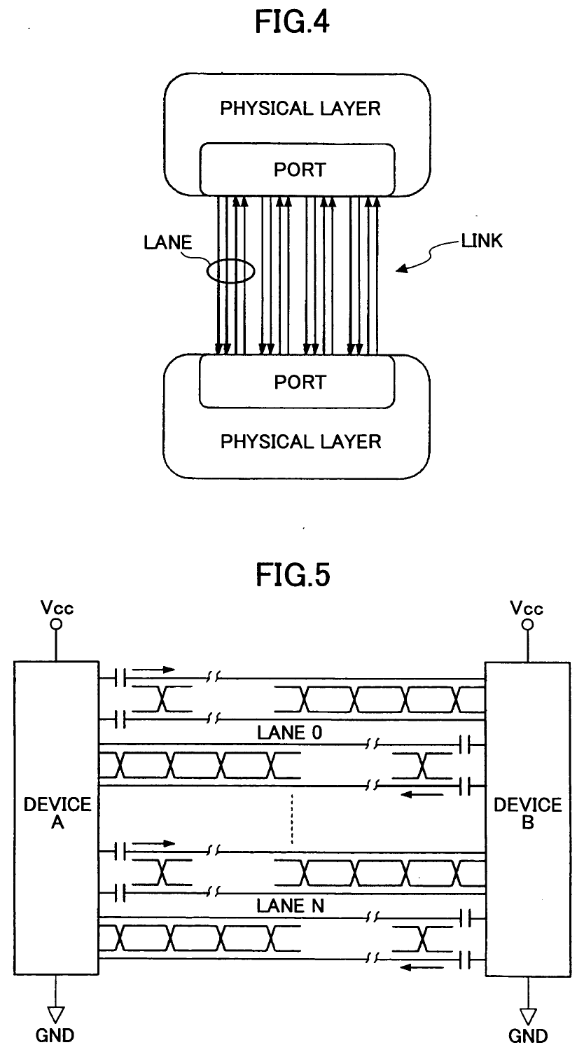

FIG. 4 is a diagram schematically showing a structure of physical layers for x4 links. Ports are physically provided within the same semiconductor device and are formed by a collection of transmitters and receivers that form links, and are logically interfaces that connect a component and a link by a point-to-point connection. For example, the transfer rate of the ports is 2.5 Gbps in one direction. Lanes are sets of differential signal pairs of 0.8 V, for example, and each lane is made up of a transmitting signal pair and a receiving signal pair. A link is a collection of two ports and the lanes connecting the two ports, and is made up of a dual simplex communication bus between the components. “xN links” are formed by N lanes, and N=1, 2, 4, 8, 16 and 32 are defined according to the current standard. FIG. 4 shows the case where N=4. For example, it is possible to form a scalable band width by varying the lane width N between devices A and B. FIG. 5 is a diagram schematically showing the lanes connecting the devices A and B.

B. Root Complex:

The root complex 112 is located at an uppermost layer of the I/O structure, and connects a CPU, a memory subsystem and the like to the I/O. In block diagrams or the like, the root complex 112 is often indicated as the “memory hub” 124 as shown in FIG. 3. The root complex 112 (or memory hub 124) has one or more PCI Express ports (root ports) that are indicated by rectangular symbols within the root complex 112 in FIG. 2, and each PCI Express port forms an independent I/O hierarchical domain. The I/O hierarchical domain may be a simple end point (for example, the end point 115a in FIG. 2) or, may be formed by a large number switches and end points (for example, the end point 115b and the switches 117b and 115c in FIG. 2).

C. End Point:

The end point 115 is a device (more particularly, a device other than a bridge) having a type 00h configuration space header. The end point 115 may be categorized into a legacy end point and a PCI Express end point. The main difference between the legacy end point and the PCI Express end point is that the PCI Express end point is a Base Address Register (BAR) and does not request an I/O resource, and for this reason does not make an I/O request. In addition, the PCI Express end point does not support a lock request.

D. Switch:

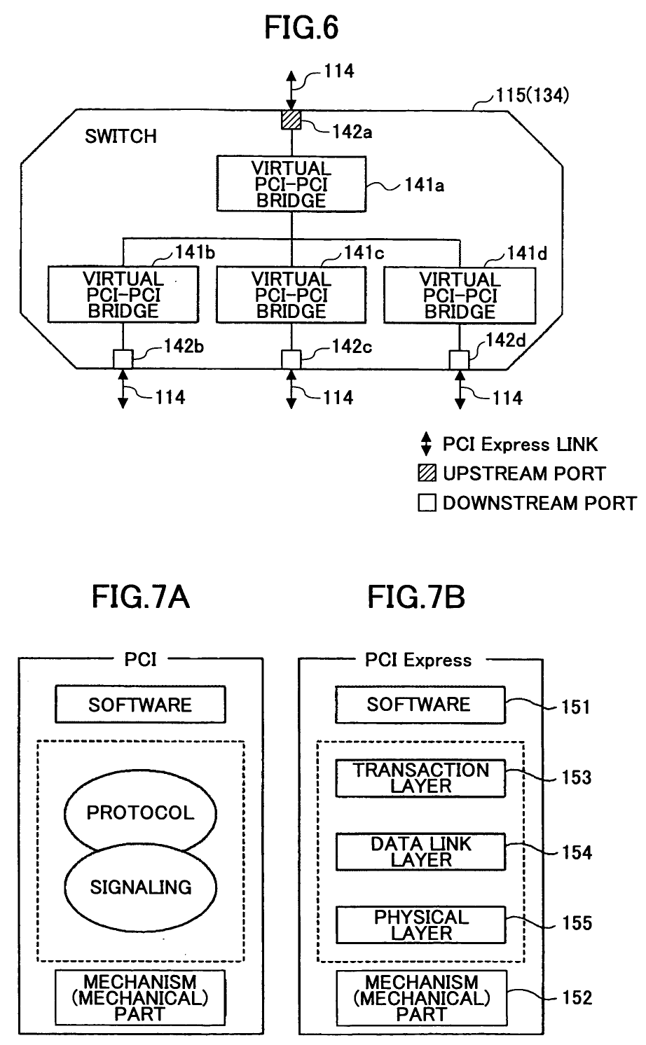

The switch 117 (or 134) connects 2 or more ports, and carries out a packet routing between the ports. From a configuration software, the switch 117 (or 134) is recognized as a collection of virtual PCI-PCI bridges 141, as shown in FIG. 6. FIG. 6 is a system block diagram showing a logical structure of the switch 117 (or 134). In FIG. 6, a two-headed arrow denotes the PCI Express link 114 (or 126), and of ports 142a through 142d, the port 142a forms an upstream port closer to the root complex, while the ports 142b through 142d form downstream ports farther away from the root complex.

E. PCI Express 114e & PCI Bridge 119:

The PCI Express 114e and the PCI bridge 119 provide a connection from the PCI Express to the PCI/PCI-X. Hence, it is possible to use existing PCI/PCI-X devices in the PCI Express system.

### Hierarchical Architecture

FIGS. 7A and 7B are system block diagrams respectively showing an existing PCI architecture and a PCI Express architecture. As shown in FIG. 7A, the existing PCI architecture has a structure in which the protocol and the signaling have a close relationship, and there is no concept of layers. On the other hand, the PCI Express architecture has an independent hierarchical structure as shown in FIG. 7B and the specifications are defined for each layer, similarly to the general communication protocol and the InfiniBand. In other words, in the hierarchical structure of the PCI Express architecture, a transaction layer 153, a data link layer 154 and a physical layer 155 are provided between a software 151 at the uppermost layer and a mechanical part 152 at the lowermost layer. Hence, according to the PCI Express architecture, the module of each layer is secured, and it is possible to achieve scalablity and to reuse the module. For example, when employing a new signal coding technique or a transmission medium, it is possible to cope with the change by simply modifying the physical layer 155 without having to modify the data link layer 154 and the transaction layer 153.

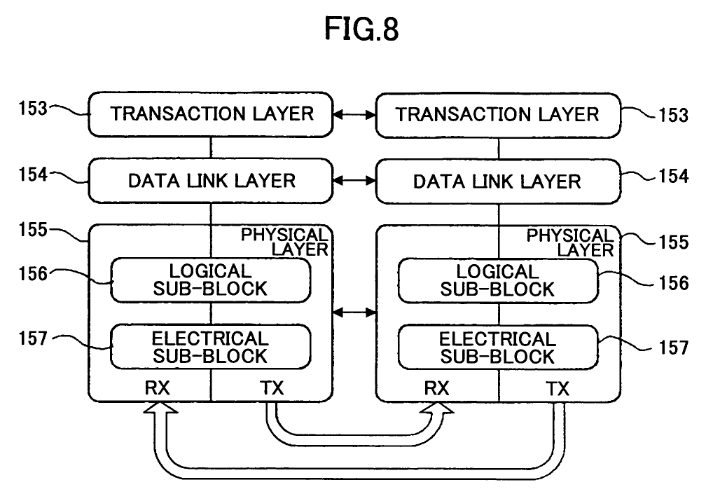

The transaction layer 153, the data link layer 154 and the physical layer 155 form the core of the PCI Express architecture. Each of the transaction layer 153, the data link layer 154 and the physical layer 155 has the following role, as described hereunder in conjunction with FIG. 8. FIG. 8 is a system block diagram showing the PCI Express hierarchical structure.

A. Transaction Layer 153:

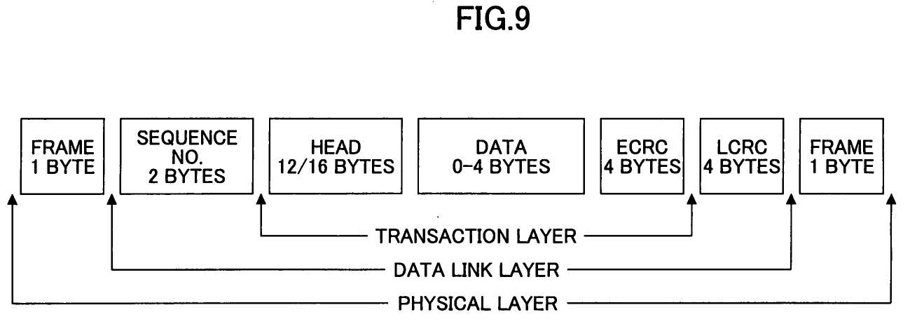

The transaction layer 153 is located at the uppermost layer of the core layers 153 through 155, and includes the functions of assembling and disassembling Transaction Layer Packets (TLPs). The TLPs are used to transfer transactions such as read and write (read/write) and various kinds of events. In addition, the transaction layer 153 carries out a flow control using credits for the TLPs. FIG. 9 is a diagram for explaining a format of the TLP in each of the core layers 153 through 155. A detailed description of FIG. 9 will be given later in the specification.

B. Data Link Layer 154:

The main role of the data link layer 154 includes guaranteeing data safety of the TLPs by error detection and correction (retransmission), and link management. The packets for link management and flow control are exchanged between the data link layers 154. In order to distinguish such packets exchanged between the data link layers 154 from the TLPs, such packets are called Data Link Layer Packets (DLLPs).

C. Physical Layer 155:

The physical layer 155 includes circuits that are necessary for an interface operation, such as drivers, input buffers, parallel-to-serial converters and serial-to-parallel converters, Phase Locked Loops (PLLs) and impedance matching circuits. As a logical function, the physical layer 155 includes the functions of making initialization and maintenance of the interface. The physical layer 155 also has the role of making the data link layer 154 and the transaction layer 153 independent of the signaling technique used by the actual links.

A technique called embedded clock is employed due to the hardware structure of the PCI Express. There is no clock signal, and the timing of the clock is embedded within the data signal. The clock is extracted at the receiving end based on a cross point of the data signal.

### Configuration Space

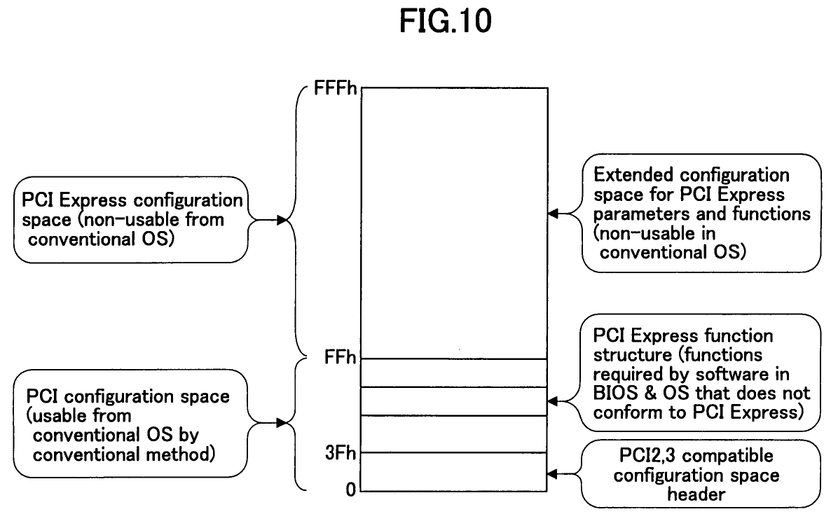

The PCI Express has a configuration space similarly as in the case of the existing PCI. But while the configuration space of the existing PCI has a size of 256 bytes, the configuration space of the PCI Express is extended to 4096 bytes as shown in FIG. 10. FIG. 10 is a diagram for explaining the configuration space of the PCI Express. Accordingly, the configuration space of the PCI Express is sufficient even with respect to devices (for example, host bridges) that require a large number of device specific register sets. According to the PCI Express, the access to the configuration space is made by an access (configuration read/write) to a flat memory space, and bus, device, function and register numbers are mapped at memory addresses.

The first 256 bytes of the memory space may be accessed as the PCI configuration space from a Basic Input Output System (BIOS) or the conventional Operating System (OS) by a method using the I/O port. The function of converting the conventional access into the access in the PCI Express is implemented in the host bridge. 00h to 3Fh are used as a PCI2.3 compatible configuration header. Accordingly, the software of the conventional OS may be used as it is for functions other than the functions extended by the PCI Express. In other words, the software layer of the PCI Express inherits the load-store architecture (a system in which the processor makes direct access to the I/O register) that maintains compatibility with the existing PCI. However, when using the functions extended by the PCI Express (for example, synchronous transfer, and Reliability, Availability and Serviceability (RAS)), it is necessary to enable access to the 4-kByte extended space of the PCI Express.

The PCI Express may take various form factors (shapes). Particular examples of the form factors include the add-in card, the plug-in card (Express Card) and the Mini PCI Express.

### Details of PCI Express Architecture

A more detailed description will be given of the transaction layer 153, the data link layer 154 and the physical layer 155 which form the core of the PCI Express architecture.

A. Transaction Layer 153:

As described above, the mail role of the transaction layer 153 is to assemble and disassemble the TLPs between the software layer 151 at the higher level and the data link layer 154 at the lower level.

a. Address Space & Transaction Type:

In addition to the memory space (for data transfer with the memory space), the I/O space (for data transfer with the I/O space) and the configuration space (for device configuration and setup) that are supported by the existing PCI, the PCI Express has a message space for general message transmission (exchange) and event notification in the in-band between PCI Express devices. Interrupt requests and confirmations are transferred by using the message as a “virtual wire”. Hence, 4 address spaces are defined with respect to the PCI Express. The transaction type is defined for each of the 4 address spaces. More particularly, the transaction type of the memory space, the I/O space and the configuration space is “read/write”, and the transaction type of the message space is “basic (including vendor definition)”.

b. Transaction Layer Packet (TLP):

According to the PCI Express, the communication is made in units of packets. In the format of the TLP shown in FIG. 9, the header length of the header is 3 DW (Double Words) or 12 bytes in total or, 4 DW or 16 bytes in total. The format of the TLP includes information such as the format (header length and existence of payload) of the TLP, the transaction type, the Traffic Class (TC), the attribute and the payload length. A maximum payload length within the packet is 1024 DW or 4096 bytes in total.

The End-to-end Cyclic Redundancy Code (ECRC) guarantees the data safety of the end-to-end, and is formed by a 32-bit CRC of the TLP portion. When an error is generated in the TLP within the switch or the like, the Link CRC (LCRC) cannot detect the error since the LCRC is recomputed from the TLP containing the error. The ECRC is provided for this reason.

The requests include those that require a completion packet and those that do not require the completion packet.

c. Traffic Class (TC) & Virtual Channel (VC):

The software at the higher level can distinguish the traffic by use of the Traffic Class (TC) and assign a priority depending on the TC. For example, it is possible to transfer video data with a priority over the network data. There are 8 TCs, namely, TC0 through TC7.

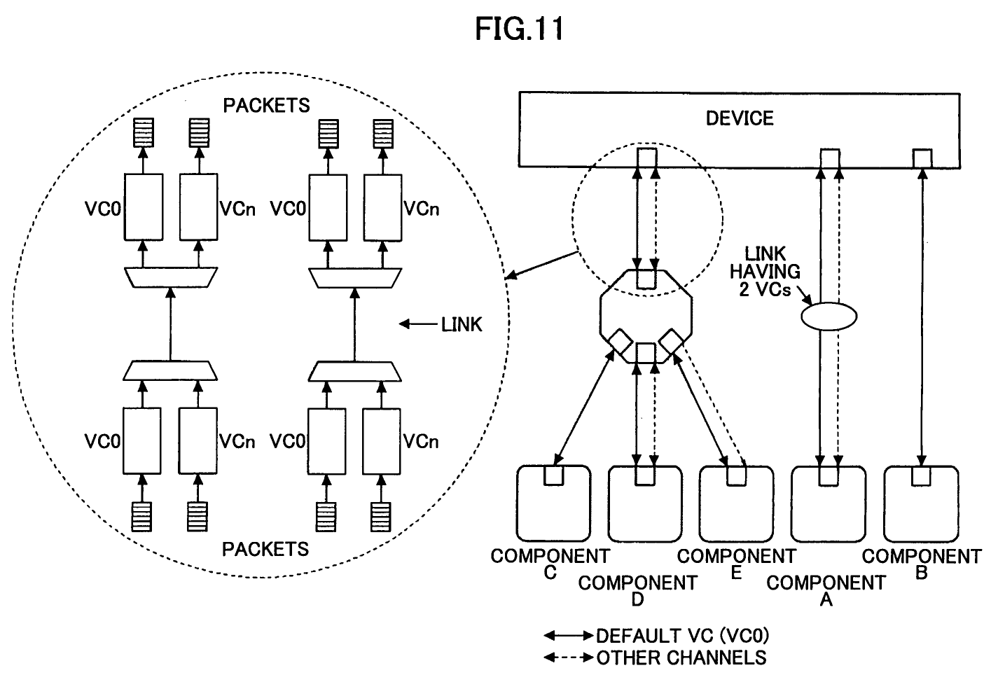

Each Virtual Channel (VC) is formed by an independent virtual communication bus (a mechanism that uses a plurality of independent data flow buffers which are shared by the same link), and has resources (buffers and queues). Each VC carries out an independent flow control as shown in FIG. 11. FIG. 11 is a diagram for schematically explaining the concept of the VC. Hence, even in a state where the buffers of one VC are full, it is possible to carry out the transfer in the other VCs. In other words, by separating the link which is physically one link into the plurality of VCs, it is possible to effectively utilize the link. For example, when the root link separates into a plurality of devices via the switch as shown in FIG. 11, it is possible to control the priority of the traffic of each device. The VC VC0 is essential, and other VCs VC1 through VC7 are implemented depending on the cost-performance tradeoff. In FIG. 11, an arrow indicated by a solid line denotes a default VC (VC0), and arrows indicated by a dotted line denote the other VCs (VC1 through VC7).

In the transaction layer 153, the TC is mapped in the VCs. It is possible to map one or a plurality of TCs with respect to one VC when the number of VCs is relatively small. In a simple case, each TC is mapped in each VC in a 1:1 relationship or, all of the TCs are mapped in the VC VC0. The TC0-VC0 mapping is essential and fixed, but the other mappings are controlled from the software in the higher level. The software can control the priority of the transaction by utilizing the TC.

d. Flow Control:

The Flow Control (FC) is carried out in order to avoid an overflow of the reception buffer and to establish a transmission sequence. The flow control is carried out with respect to the point-to-point between the links, and not with respect to the end-to-end. Accordingly, it is not possible to confirm that the packet has reached the final party (or completer) at the other end by the flow control.

The flow control of the PCI Express is carried out on a credit base (a mechanism that confirms the vacant state of the buffer at the receiving end prior to starting the data transfer, so as not to generate the overflow or underflow). In other words, the receiving end notifies the buffer capacity (credit value) to the transmitting end at the time of the link initialization, and the transmitting end compares the credit value and the length of the transmitting packet and transmits the packet only when a predetermined remainder exists. There are 6 kinds of credits.

The flow control carries out the information exchange using the Data Link Layer Packet (DLLP) of the data link layer 154. The flow control is only applied to the TLP, and is not applied to the DLLP (the DLLP is always transmittable and receivable).

B. Data Link Layer 154:

As described above, the main role of the data link layer 154 is to provide a highly reliable TLP exchange function between 2 components in the link.

a. Treating Transaction Layer Packet (TLP):

With respect to the TLP received from the transaction layer 153, a 2-byte sequence number is added to the start and a 4-byte Link CRC (LCRC) is added to the end, before supplying the TLP to the physical layer 155, as shown in FIG. 9. The TLP is stored in a retry buffer, and is retransmitted until a reception confirmation (or ACK: Acknowledge) is received from the other party. If the transmission of the TLP fails in succession, it is judged that a link abnormality exists, and a link retraining request is made with respect to the physical layer 155. If the link retraining fails, the state of the data link layer 154 makes a transition to an inactive state.

The sequence number and the LCRC of the TLP received from the physical layer 155 are checked, and the TLP is supplied to the transaction layer 153 if normal. If an error is detected in the sequence number and/or the LCRC, a retransmission is requested.

b. Data Link Layer Packet (DLLP):

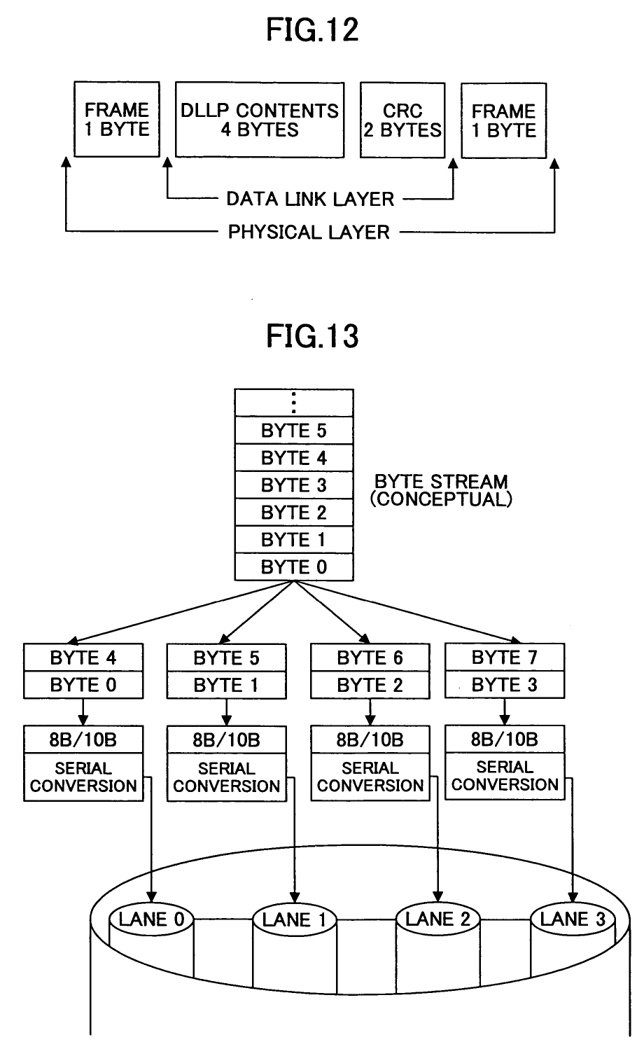

The TLP is automatically separated into the DLLPs shown in FIG. 12 that are transmitted to each of the lanes, when being transmitted from the physical layer 155. FIG. 12 is a diagram showing a format of the DLLP. The packet generated in the data link layer 154 is called the DLLP, and this DLLP is exchanged between the data link layers 154. The types of the DLLP include Ack/Nak for reception confirmation (acknowledge, not acknowledge) of the TLP and the retry (retransmission), InitFC1, InitFC2 and UpdateFC for initialization and updating of the flow control, and DLLP for power supply management.

As shown in FIG. 12, the DLLP has a length of 6 bytes, and is formed by a DLLP type (1 byte) that indicates the type of DLLP, specific information (3 bytes) specific (peculiar) to the type of DLLP, and a CRC (2 bytes).

C. Physical Layer-Logical Sub-Block 156:

The main role of a physical sub-block 156 of the physical layer 155 shown in FIG. 8 is to convert the packet received from the data link layer 154 into a format transmittable in an electrical sub-block 157. The logical sub-block 157 also has a function of controlling and managing the physical layer 155.

a. Data Encoding & Parallel-To-Serial Conversion:

The PCI Express uses an 8B/10B conversion for the data encoding, so that consecutive “0”s or “1”s do not continue (so that a state where no cross point exists will not continue for a long time). As shown in FIG. 13, the converted data is subjected to a serial conversion, and transmitted to the lane from the Least Significant Bit (LSB). FIG. 13 is a diagram schematically showing a byte striping for x4 links. In a case where a plurality of lanes are provided (FIG. 13 shows the case for x4 links), the serially converted data are allocated to each of the lanes in units of bytes prior to the encoding. In this case, although the arrangement at first glance looks like a parallel bus, the transfer is carried out independent for each lane, and the problem of the skew generated in the parallel bus is greatly suppressed.

b. Power Supply Management & Link State:

In order to reduce the power consumption of the link to a low value, L0, L0s, L1 and L2 states are defined as the link states as shown in Table 1.

TABLE 1

| | | Time Required to |
|---|---|---|
| State | Description | Return to L0 |
| L0 | Active (Normal) | — |
| L0s | Link is common | 16 ns to 4 μs |
| | mode voltage, | |
| | clock & main | |
| | power supply are | |
| | ON | |
| L1 | Link is common | 1 μs to several |
| | mode voltage, | tens of μs |
| | clock is OFF & | |
| | main power supply | |
| | is ON | |
| L2 | Clock & main | System Dependent |
| | power supply are | |
| | OFF, auxiliary | |
| | power supply | |
| | (Vaux) is | |
| | supplied if any | |

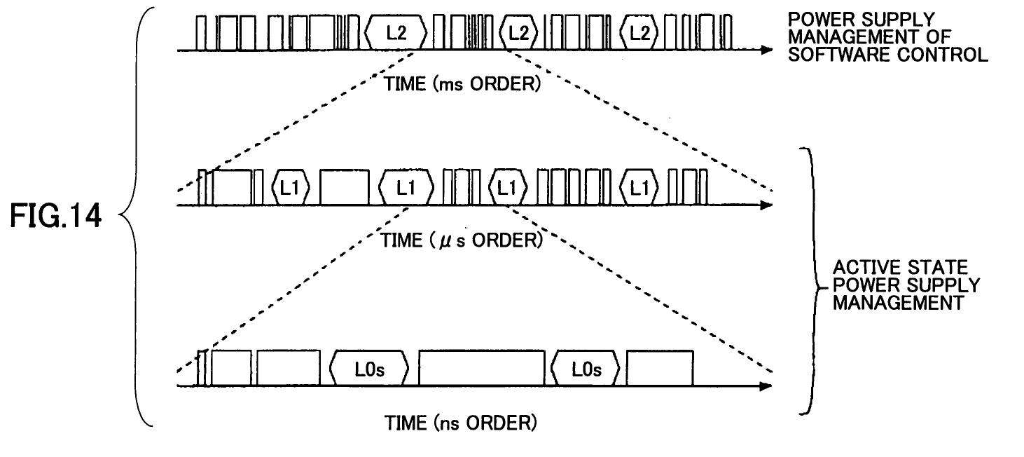

The L0 state is the normal mode, and the power consumption becomes lower from the L0s state towards the L2 state. The lower the power consumption, the more time required to return to the L0 state. The return time from the L2 state depends on the power supply, the PLL rise time and the like. FIG. 14 is a time chart for explaining a control of the active state power supply management. As shown in FIG. 14, by positively carrying out the active state power supply management in addition to the power supply management by the software, it becomes possible to minimize the power consumption.

D. Physical Layer-Electrical Sub-Block 157:

The main role of the electrical sub-block 157 of the physical layer 155 shown in FIG. 8 is to transmit the data that have been serially converted in the logical sub-block 156 to the lane, and to receive the data on the lane and supply the data to the logical sub-block 156.

a. AC Coupling:

At the transmitting end of the link, an AC coupling capacitor is mounted. Hence, the DC common mode voltage does not have to be the same at the transmitting end and the receiving end. For this reason, different designs, semiconductor processes and power supply voltages may be used between the transmitting end and the receiving end.

b. Deemphasis:

According to the PCI Express, the 8B/10B encoding is employed as described above so as to avoid consecutive “0”s or “1”s from continuing. However, there are cases where consecutive “0”s or “1”s continue (5 times at the maximum). In such a case, it is prescribed in the PCI Express that the transmitting end must carry out a deemphasis transfer. If consecutive bits of the same polarity occur, the differential voltage level (amplitude) must be dropped by 3.5±0.5 dB from the second bit so as to increase the noise margin of the signal received at the receiving end, that is, the so-called deemphasis is carried out. Due to the frequency-dependent attenuation of the transmission path, the amount of high-frequency components is large in the case of a changing bit, and the waveform becomes small at the receiving end because of the attenuation. On the other hand, the amount of high-frequency components is small in the case of a bit that does not change, and the waveform becomes relatively large at the receiving end. For this reason, the deemphasis is carried out to make the size of the waveform constant at the receiving end.

### Image Forming System

In this embodiment of the image forming system such as the digital copying apparatus and the MFP, a high-speed serial bus employing the PCI Express standard described above is used for an internal interface.

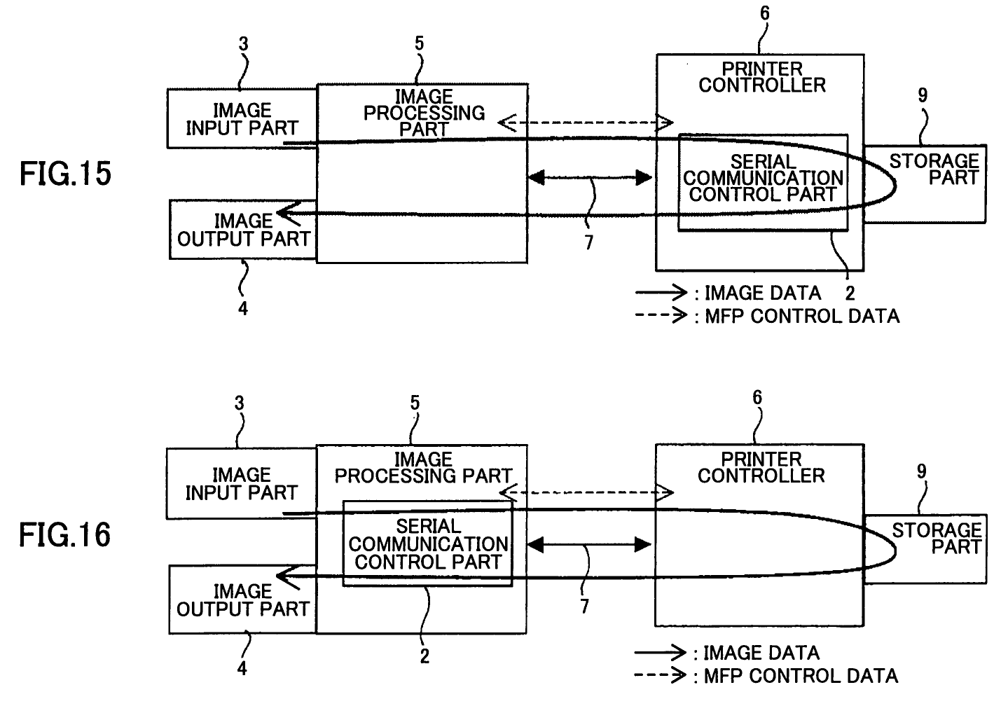

FIG. 15 is a system block diagram generally showing this embodiment of the image forming system according to the present invention. In this embodiment, an image forming system 1 is applied to an equipment such as the MFP, and includes a serial communication control part 2, an image input part 3, an image output part 4, an image processing part 5, a printer controller 6 and a storage part 9. The serial communication control part 2 includes a processor such as a CPU that controls a serial communication system based on an installed program (or software), and is formed by a device part for carrying out processes such as route control and route judgement. The serial communication control part 2 corresponds to a root complex of the PCI Express standard.

The image input part 3 is formed by a device or unit part that inputs image data based on a document image or the like to the image forming system 1. For example, the image input part 3 is formed by a scanner engine or the like that acquires the image data by photoelectrically reading the document image. The image output part 4 is formed by a device or unit part that outputs the image data by printing the image data on a recording medium such as paper. For example, the image output part 4 is formed by an electrophotography type plotter (or printer) engine or the like.

The image processing part 5 is formed by a device or unit part that subjects the image data to an image processing such as γ-correction, color conversion, shading correction, gradation correction, texture correction, enlarging and reducing, rotation, and compression and expansion. For example, the image processing part 5 is formed by various image corrector, color converter, magnifying unit (or zoom unit), rotating unit, compressor and expander, and the like. The printer controller 6 includes a processor such as a CPU that controls the entire image forming system 1 according to an installed program (or software), and is formed by a device or unit part that controls the printer operation or the MFP operation. The storage part 9 is formed by a device or unit part that stores image data, such as a memory and a Hard Disk Drive (HDD).

In the image forming system 1 of this embodiment, the image processing part 5 integrally comprises the image input part 3 and the image output part 4. In addition, the printer controller 6 includes the serial communication control part 2, and integrally comprises the storage part 9. Moreover, the image processing part 5 and the printer controller 6 are connected by a high-speed serial bus 7 in conformance with the PCI Express standard. Hence, the devices that are connected by the high-speed serial bus 7, namely, the image processing part 5 and the printer controller 6, have ports.

Under the control of the serial communication control part 2, the image data input from the image input part 3 are subjected to the image processing in the image processing part 5 if necessary, and transferred to the printer controller 6 via the high-speed serial bus 7. The image data transferred to the printer controller 6 are temporarily stored in the storage part 9 within the printer controller 6. Thereafter, the image data stored in the storage part 9 of the printer controller 6 are input to the image processing part 5 via the high-speed serial bus 7 and subjected to the image processing if necessary, and then transferred to the image output part 4 which prints the image data, for example. In FIG. 15, a dotted line indicates the flow of the image processing system (MFP) control data, and similar designations are used in the subsequent drawings.

According to this embodiment, the image processing part 5 and the printer controller 6 are connected within the image forming system 1 by the high-speed serial bus 7 in conformance with the PCI Express standard. For this reason, the electrical systems of the devices may be mounted on separate boards (or substrates) on the side of the image processing part 5 and on the side of the printer controller 6. Consequently, the degree of freedom of design of the image forming system 1 is greatly extended without sacrificing the high-speed operation, and the cost of the image forming system 1 can be reduced by the reduced area of the boards (or substrates). In addition, since the printer controller 6 includes the serial communication control part 2, it is possible to use the CPU resource of the printer controller 6 in common between the printer controller 6 and the serial communication control part 2.

The present invention is not limited to the structure of the image forming system 1 shown in FIG. 15, and various modifications may be made as described hereunder.

FIG. 16 is a system block diagram generally showing a first modification of the embodiment of the image forming system according to the present invention. In this modification, the serial communication control part 2 is provided within the image processing part 5. Since the image processing part 5 includes the serial communication control part 2, it is possible to use the CPU resource of the image processing part 5 in common between the image processing part 5 and the serial communication control part 2. As a result, it is possible to easily extend the application by connecting the printer controller 6 afterwards, such as when extending the copying function to the MFP function.

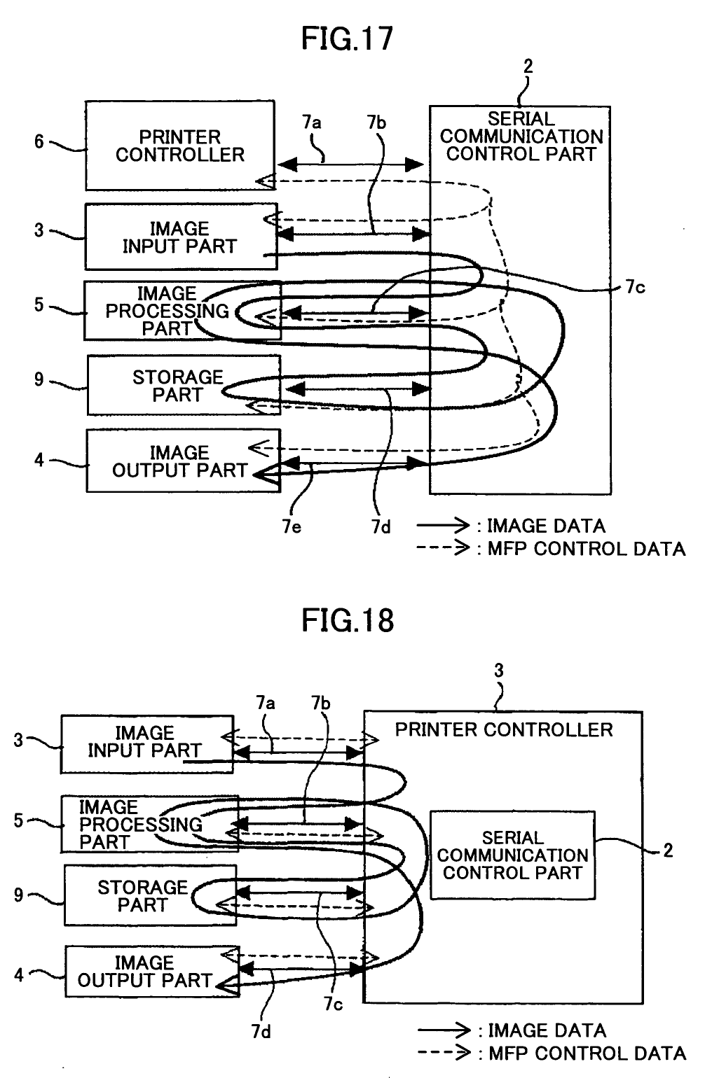

FIG. 17 is a system block diagram generally showing a second modification of the embodiment of the image forming system according to the present invention. In this modification, the printer controller 6, the image input part 3, the image processing part 5, the storage part 9 and the image output part 4 are independently connected to the serial communication control part 2 via corresponding high-speed serial buses 7a through 7e, so that the serial communication control part 2 is separate or independent and the printer controller 6, the image input part 3, the image processing part 5, the storage part 9 and the image output part 4 can be treated equally by the serial communication control part 2. Hence, the serial communication control part 2 in this case may easily be realized by using a root complex that is located at a root of a tree structure of the PCI Express system, for example.

Therefore, the image data input by the image input part 3 are transferred to the serial communication control part 2 via the high-speed serial bus 7b, and then transferred to the image processing part 5 via the high-speed serial bus 7c to be subjected to the necessary image processing. The image data are then temporarily stored in the storage part 9 via the high-speed serial bus 7d, and again transferred to the image processing part 5 to be subjected to the necessary image processing via the high-speed serial buses 7d and 7c. The image data are further transferred to the image output part 4 via the high-speed serial buses 7c and 7e, and printed, for example. Hence, of the elements constituting the image forming system 1, the serial communication control part 2 is separate or independent, thereby making it possible to maximize the degree of freedom of extending the application.

FIG. 18 is a system block diagram generally showing a third modification of the embodiment of the image forming system according to the present invention. In this modification, the input part 3, the image processing part 5, the storage part 9 and the image output part 4 are separately connected with respect to the serial communication control part 2 which includes the printer controller 6 via corresponding high-speed serial buses 7a through 7d, so that the image input part 3, the image processing part 5, the storage part 9 and the image output part 4 can be treated equally by the printer controller 6. The serial communication control part 2 in this case may also be easily realized by using a root complex that is located at a root of a tree structure of the PCI Express system, for example.

Accordingly, the image data input from the image input part 3 are transferred to the printer controller 6 via the high-speed serial bus 7a, for example, and transferred to the image processing part 5 via the high-speed serial bus 7b to be subjected to the necessary image processing. The image data are further transferred to the storage part 9 via the high-speed serial bus 7b and temporarily stored in the storage part 9. The image data are then again transferred to the image processing part 5 via the high-speed serial buses 7c and 7b to be subjected to the necessary image processing. The image data are further transferred to the image output part 4 via the high-speed serial buses 7b and 7d, and printed, for example. Therefore, in addition to the effects obtainable by the modification shown in FIG. 15, it is possible to increase the degree of freedom of extending the image input part 3 and the image output part 4.

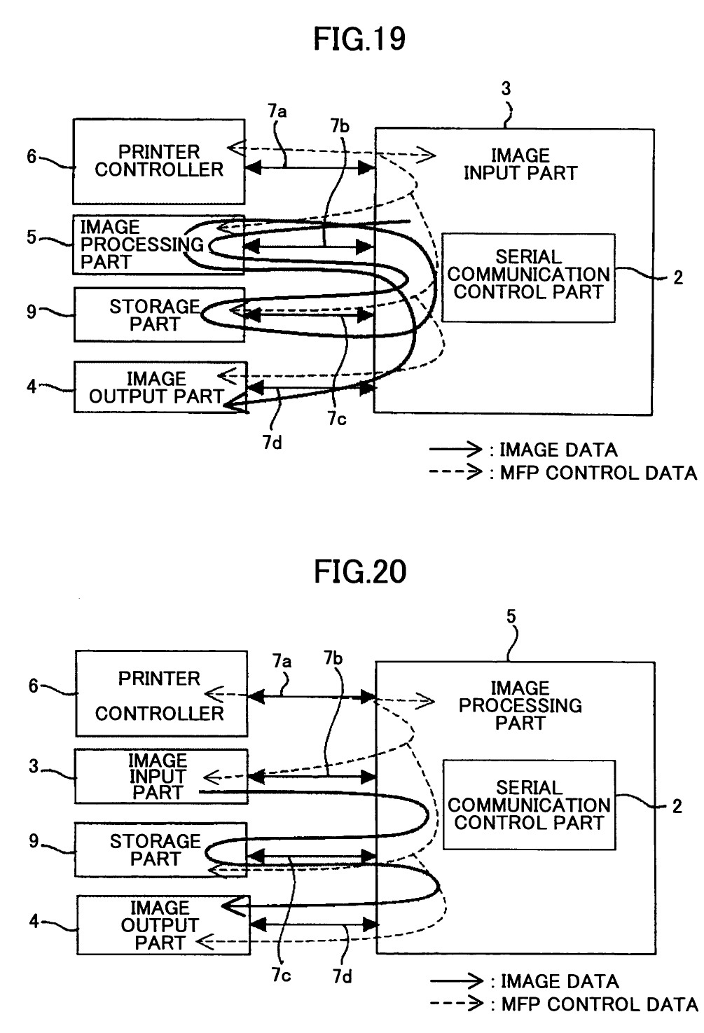

FIG. 19 is a system block diagram generally showing a fourth modification of the embodiment of the image forming system according to the present invention. When compared to the modification shown in FIG. 18, the image input part 3 and the printer controller 6 are interchanged in this modification shown in FIG. 19. Since the image input part 3 includes the serial communication control part 2, it is possible to use the CPU resource of the image input part 3 in common between the image input part 3 and the serial communication control part 2. In addition, it is possible to easily extend the application by using the application of the image input part 3 as a base, such as when providing other functions afterwards.

FIG. 20 is a system block diagram generally showing a fifth modification of the embodiment of the image forming system according to the present invention. When compared to the modification shown in FIG. 18, the image processing part 5 and the printer controller 6 are interchanged in this modification shown in FIG. 20. Since the image processing part 5 includes the serial communication control part 2, it is possible to use the CPU resource of the image processing part 5 in common between the image processing part 5 and the serial communication control part 2.

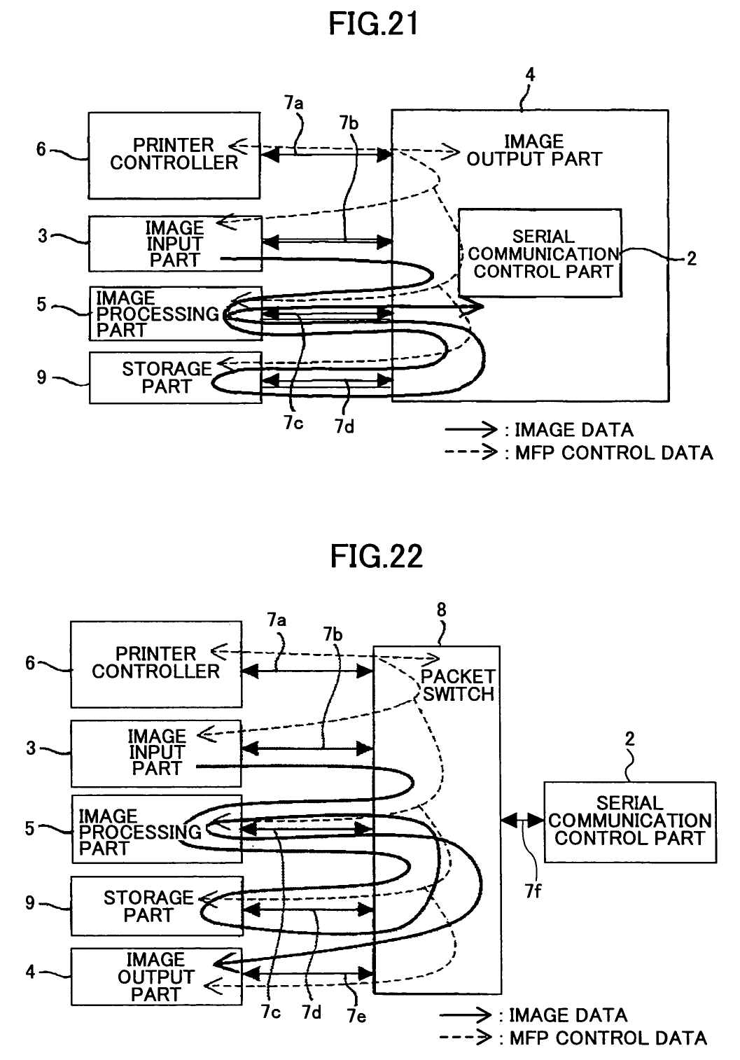

FIG. 21 is a system block diagram generally showing a sixth modification of the embodiment of the image forming system according to the present invention. When compared to the modification shown in FIG. 18, the image output part 4 and the printer controller 6 are interchanged in this modification shown in FIG. 21. Since the image output part 4 includes the serial communication control part 2, it is possible to use the CPU resource of the image output part 4 in common between the image output part 4 and the serial communication control part 2. In addition, it is possible to easily extend the application by using the application of the image output part 4 as a base, such as when providing other functions afterwards.

FIG. 22 is a system block diagram generally showing a seventh modification of the embodiment of the image forming system according to the present invention. When compared to the modification shown in FIG. 17, a packet switch 8 of the tree structure of the PCI Express system is arranged on the downstream side of the serial communication control part 2 via a high-speed serial bus 7f in this modification shown in FIG. 22. In addition, the printer controller 6, the image input part 3, the image processing part 5, the storage part 9 and the image output part 4 are arranged on the downstream side of the packet switch 8 via the corresponding high-speed serial buses 7a through 7e.

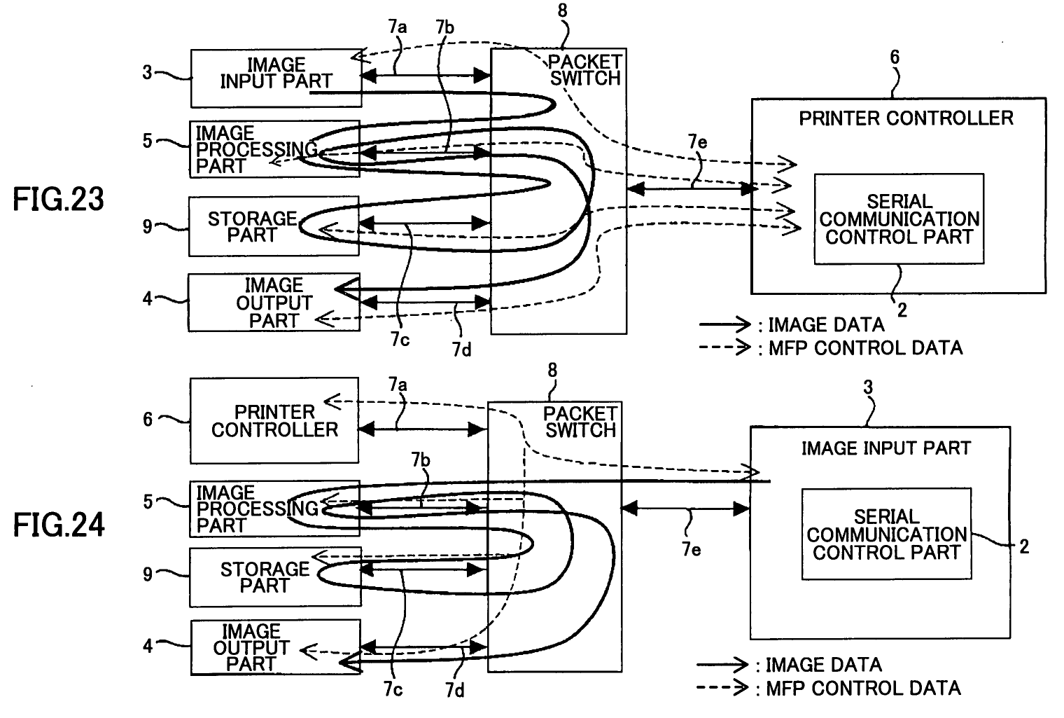

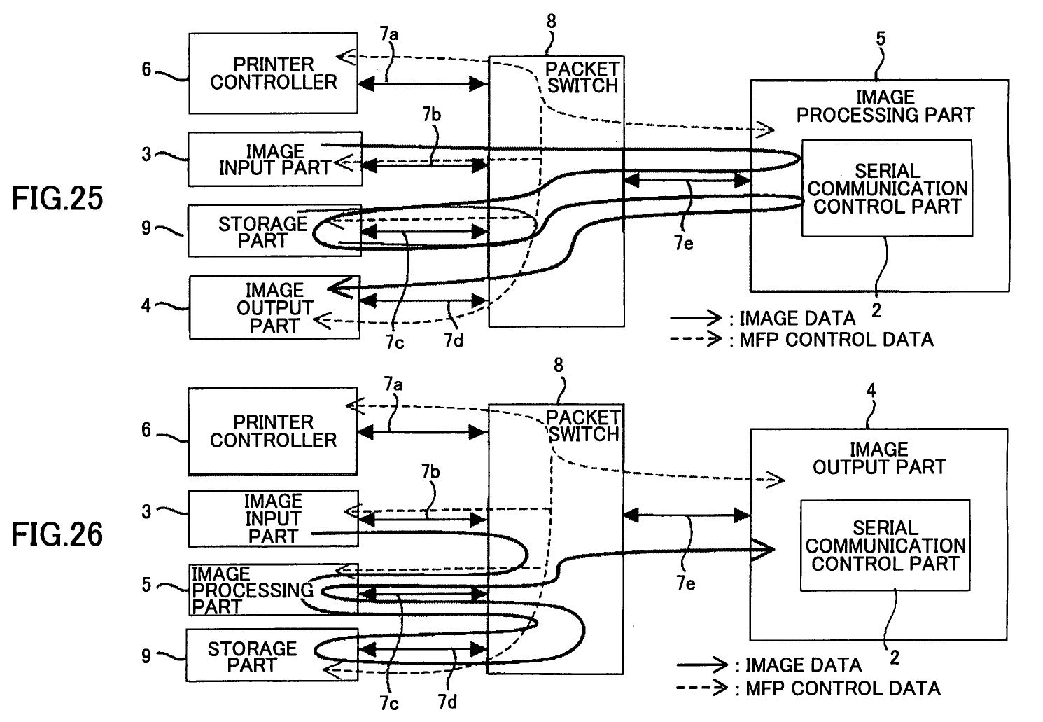

FIG. 23 is a system block diagram generally showing an eighth modification of the embodiment of the image forming system according to the present invention. FIG. 24 is a system block diagram generally showing a ninth modification of the embodiment of the image forming system according to the present invention. FIG. 25 is a system block diagram generally showing a tenth modification of the embodiment of the image forming system according to the present invention. FIG. 26 is a system block diagram generally showing an eleventh modification of the embodiment of the image forming system according to the present invention. In the modifications shown in FIGS. 23 through 26, the packet switch 8 of the tree structure of the PCI Express system is arranged similarly to the modification shown in FIG. 22, in the corresponding modifications shown in FIGS. 18 through 21. The packet switch 8 is a device, a device group or a unit that has a function of routing the communication packet of the high-speed serial interface. Hence, in the described modifications, a switch in conformance with the PCI Express standard is used as the packet switch 8.

When the packet switch 8 is provided in the route of the high-speed serial bus 7, it becomes unnecessary for the constituent element (of the image forming system 1) that includes the serial communication control part 2 to have a plurality of outputs. In addition, it becomes possible to extend the application based on the extensibility of the packet switch 8, thereby further improving the extensibility of the application.

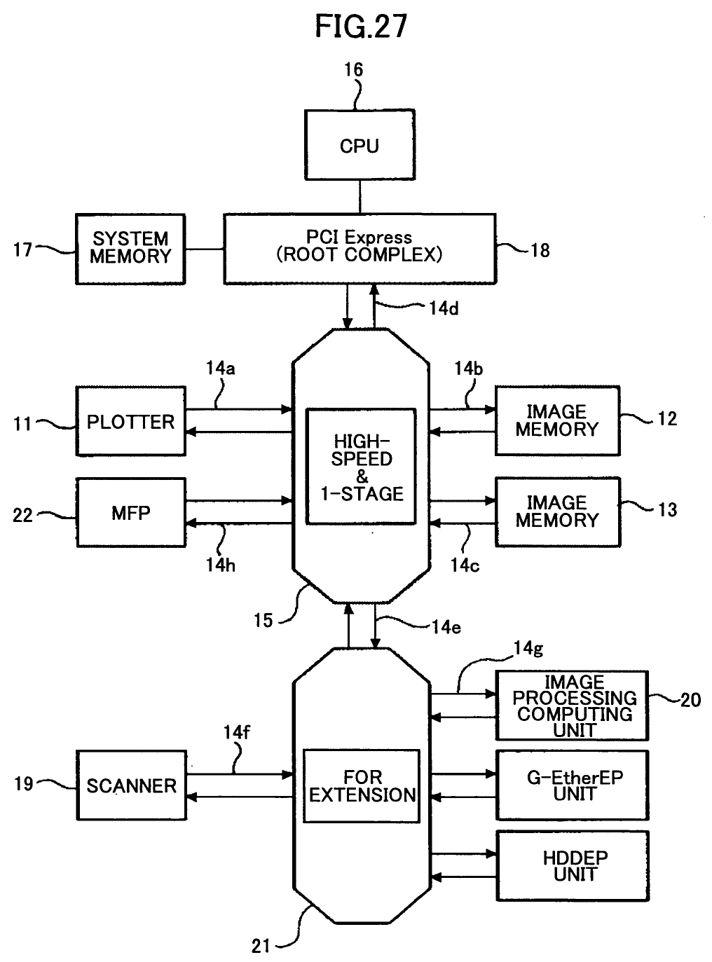

Next, a description will be given of a second embodiment of the image forming system according to the present invention, which improves the extensibility and the high-speed operation, by arranging the switch (packet switch) of the tree structure of the PCI Express system in the route of the high-speed serial bus, by referring to FIG. 27. FIG. 27 is a system block diagram showing this second embodiment of the image forming system according to the present invention, which corresponds to a best mode of the present invention. Unlike the image forming system shown in FIG. 15 which is made up of a single equipment such as the MFP, the image forming system shown in FIG. 27 is made up of a plurality of equipments that are connected.

Basically, a plotter (or printer) 11 corresponding to the image output part and image memories 12 and 13 corresponding to the storage part are connected to only one stage of a switch 15 in conformance with the PCI Express standard near each other via high-speed serial buses 14a, 14b and 14c in conformance with the PCI Express standard. For example, the image memories 12 and 13 are formed by an exclusive memory that stores final dot data to be printed and output from the plotter 11. However, it is not essential for the image memories 12 and 13 to store the final dot data. In a case where a real-time compressor and expander or the like is provided in the intermediate route, the image memories 12 and 13 may store compressed data.

In addition to the basic structure in which the plotter 11 and the image memories 12 and 13 are connected near each other via the one stage of switch 15, a root complex 18 corresponding to the serial communication control part and connected to a CPU 16 and a memory 17 may be connected to the upstream side of the switch 15 via a high-speed serial bus 14d in conformance with the PCI Express standard. Furthermore, when connecting a scanner 19 corresponding to the image input part, an image processing and computing unit 20 corresponding to the image processing part and the like which have no timing restrictions or may be relatively slow, such elements may be connected via high-speed serial buses 14e, 14f and 14g in conformance with the PCI Express standard by providing a switch 21 for extension and in conformance with the PCI Express standard on the downstream side of the switch 15. In other words, by providing the switch 15, it is possible to arbitrarily form the image forming system based on the extensibility of the switch 15. In addition, because the plotter 11 and the image memories 12 and 13 which require strict timing control from the point of view of the high-speed operation, such as the need to transfer the image data in synchronism with a line synchronizing signal, are connected near each other, it is possible to suppress the delay of the data transfer and to cope with the high-speed data transfer from the image memory 12 or 13 to the plotter 11.

In the image forming system shown in FIG. 27, an MFP 22 which includes both a scanner that functions as an image input part and a plotter that functions as an image output part is also connected to the switch 15 via a high-speed serial bus 14h in conformance with the PCI Express standard, similarly to the plotter 11, because a common interface may be used. In this case, the plotter within the MFP 22 and the image memories 12 and 13 are connected to the one stage of switch 15 near each other via the high-speed serial buses 14h, 14b and 14c. Hence, the transfer of the image data in synchronism with the line synchronizing signal from the image memory 12 or 13 to the plotter of the MFP 22 can be carried out without delay.

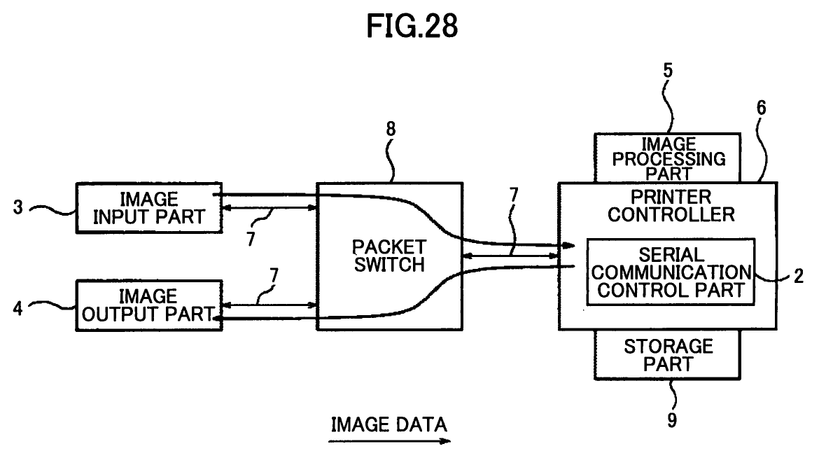

Next, a more detailed description will be given with respect to the data transfer in the image forming systems described above. For example, suppose that the printer controller 6 which integrally comprises the image processing part 5 and the storage part 9 includes the serial communication control part 2 as shown in FIG. 28. FIG. 28 is a system block diagram generally showing a structure of the image forming system. In addition, suppose that the data transfer can be made from the image input part 3 directly to the printer controller 6 (via the packet switch 8 if necessary), and that the data transfer can be made from the printer controller 6 directly to the image output part 4 (via the packet switch 8 if necessary). The data transfer system that may be applied to such a structure shown in FIG. 28 basically transfers the image data from the image input part 3 to the printer controller 6 in synchronism with the line synchronizing signal, and transfers the image data from the printer controller 6 to the image output part 4 in synchronism with the line synchronizing signal, via the high-speed serial bus 7. In this case, it is desirable that the data transfer system enables the data transfer from the printer controller 6 to the image output part 4 with a priority over the data transfer from the image input part 3 to the printer controller 6. This data transfer system is similarly applicable to any of the structures shown in FIGS. 15, 16, 18 and 22 through 26 described above.

More particularly, in one embodiment of the present invention, the data transfer system uses the image input part 3 and the image output part 4 as an initiator of the image data transfer. In addition, a memory write transaction is used in the image input part 3, and a memory read transaction is used in the image output part 4. Furthermore, the memory write transaction and the memory read transaction are allocated to different Traffic Classes (TCs). By setting a Virtual Channel (VC), the priority of the TC of the memory read transaction used in the image output part 4 is set higher than the priority of the TC of the memory write transaction used in the image input part 3. Moreover, by setting a strict priority so that the memory write transaction is issued after the entire memory read transaction is issued, it becomes possible to output the image data at a high speed even if the timing restrictions of the line synchronous transfer exist, and a plurality of image data transfers can be carried out simultaneously.

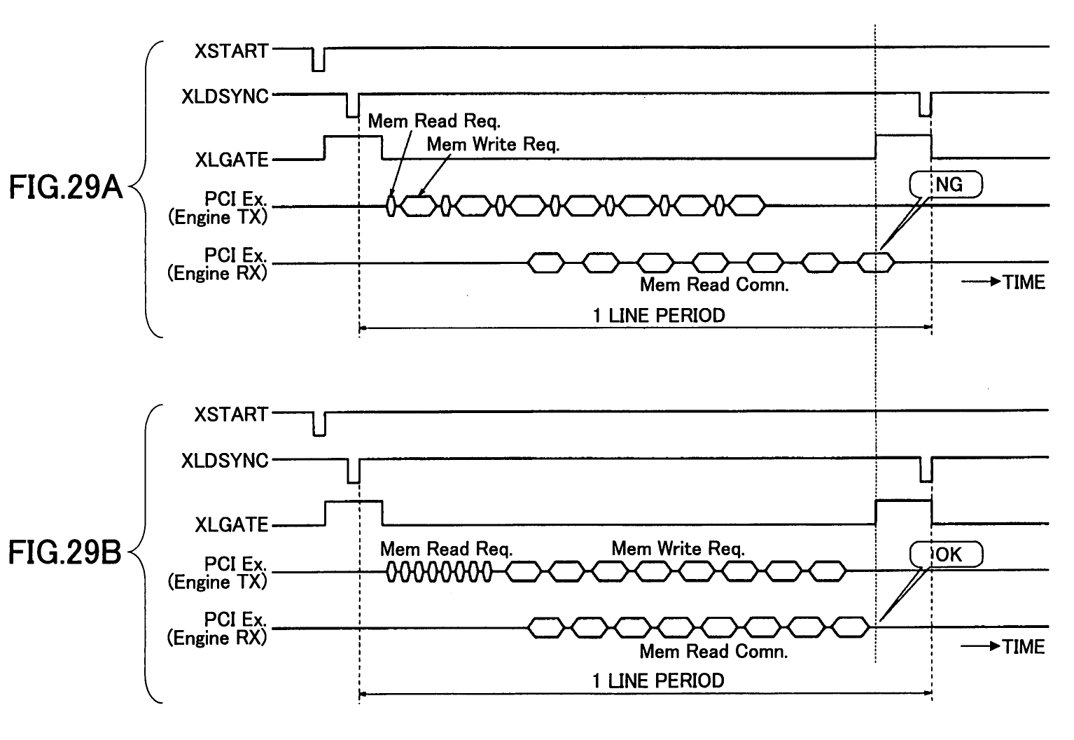

FIGS. 29A and 29B are timing charts schematically showing a command issuing sequence.

FIG. 29A shows a case where a transmission is made using the high-speed serial bus 7 in synchronism with a line synchronizing signal XLDSYNC without setting the priority with respect to an image data read request command MemReadReq. and a memory write request command MemWriteReq., and a memory read command MemReadComn. is received according to the read request command MemReadReq. In the particular case shown in FIG. 29A, the read request command MemReadReq. cannot be received within a line effective time XLGATE due to the timing restrictions of the line synchronous transfer.

On the other hand, FIG. 29B shows a case similar to that shown in FIG. 29A, but the priority of the TC of the memory read transaction (read request command MemReadReq.) of the image output part (Engine TX) is set higher than the priority of the TC of the memory write transaction (memory write request command MemWriteReq.) of the image input part 3 (Engine RX), and the strict priority is set so that the memory write transaction is issued after the entire memory read transaction is issued. Accordingly, the image data can be output at a high speed even though the timing restrictions of the line synchronous transfer exist. As a result, the read request command MemReadReq. can be received within the line effective time XLGATE, and a plurality of image data transfers can be carried out simultaneously.

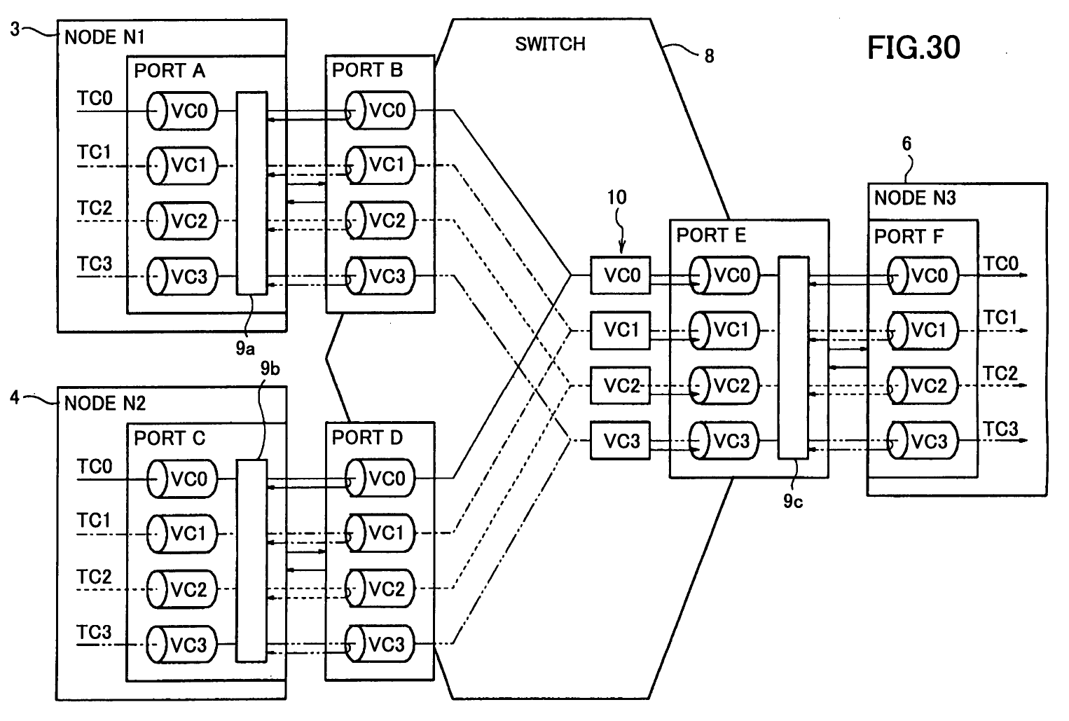

Next, a description will be given of a mechanism of the data transfer system when interposing the switch 8 (or switch 15) and using the high-speed serial bus 7 to transfer the image data from the image input part 3 to the printer controller 6 in synchronism with the line synchronizing signal and to transfer the image data from the printer controller 6 to the image output part 4 in synchronism with the line synchronizing signal, by placing priority on the data transfer from the printer controller 6 to the image output part 4 over the data transfer from the image input part 3 to the printer controller 6, by referring to FIG. 30. FIG. 30 is a diagram generally showing the mechanism of this data transfer system. In the particular case shown in FIG. 30, different ports B, D and E of the switch 8 are physically connected to corresponding nodes N1, N2 and N3 via a corresponding one of nodes A, C and F. For example, the node N1 corresponds to the image input part 3, the node N2 corresponds to the image output part 4, and the node N3 corresponds to the printer controller 6 which integrally comprises the image processing part 5 and the storage part 9 (refer to the system structure shown in FIG. 27).

The data transfer system uses the image input part 3 and the image output part 4 as the initiators of the image data transfer, and the memory write transaction is used in the image input part 3 while the memory read transaction is used in the image output part 4. Moreover, the memory write transaction and the memory read transaction are allocated to the same TC. In this particular case, 4 TCs TC0 through TC3 are allocated, and in 4 routes indicated by different kinds of lines (solid, one-dot chain, dotted and two-dot chain lines), the memory write transaction and the memory read transaction are allocated to the same TC. In addition, Virtual Channels (VCs) VC0 through VC3 are provided within the ports A, C and F of the nodes N1, N2 and N3, and the priority related to the TCs TC0 through TC3 can be set with respect to the VCs VC0 through VC3 according to the PCI Express standard. The VCs VC0 through VC3 to be allocated with respect to the TCs TC0 through TC3 are set in each of the ports A, C and F of the nodes N1, N2 and N3. The VCs VC0 through VC3 corresponding to the ports A, C and F are also allocated with respect to input ports B and D and an output port E of the switch 8. VC arbitrations 9a, 9b and 9c are provided within the corresponding ports A, C and E. The VC arbitration 9a carries out an arbitration and a serialization among the VCs VC0 through VC3 of the ports A and B. The VC arbitration 9b carries out an arbitration and a serialization among the VCs VC0 through VC3 of the ports C and D. The VC arbitration 9c carries out an arbitration and a serialization among the VCs VC0 through VC3 of the ports E and F.

In addition, a port arbitration 10 that connects to the input ports B and D is provided within the switch 8. The port arbitration 10 carries out an arbitration with respect to the port E, so that the image data transfer from the node N3 (printer controller 6) to the node N2 (image output part 4) is carried out with priority over the image data transfer from the node N1 (image input part 3) to the node N3 (printer controller 6). If 2 traffics are received from the input ports B and D, the port arbitration 10 temporarily gathers those having the same TCs TC0 through TC3, and carries out the arbitration with respect to those having the same VCs VC0 through VC3 based on the different priorities that are set for the input ports B and D. Hence, each of the VCs VC0 through VC3 that remain after the arbitration due to the different priorities set for the input ports B and D is serialized by the VC arbitration 9c and transferred to the node N3 (printer controller 6).

When using the mechanism of the data transfer system described above in conformance with the PCI Express standard to transfer the image data from the node N3 (printer controller 6) to the node N2 (image output part 4) with priority over the transfer of the image data from the node N1 (image input part 3) to the node N3 (printer controller 6), a traffic distribution algorithm employed in the port arbitration 10 may be selected from any of Round Robin (RR), Weighted Round Robin (WRR) and Time Base Weighted Round Robin (TBWRR) which includes management of the concept of time, in accordance with the PCI Express standard. When employing the WRR algorithm, it is preferable to take into consideration the payload size. It is also preferable to take into consideration the payload size when employing the RR or TBWRR algorithm. By taking into consideration the payload size, it becomes possible to realize a more detailed priority control.

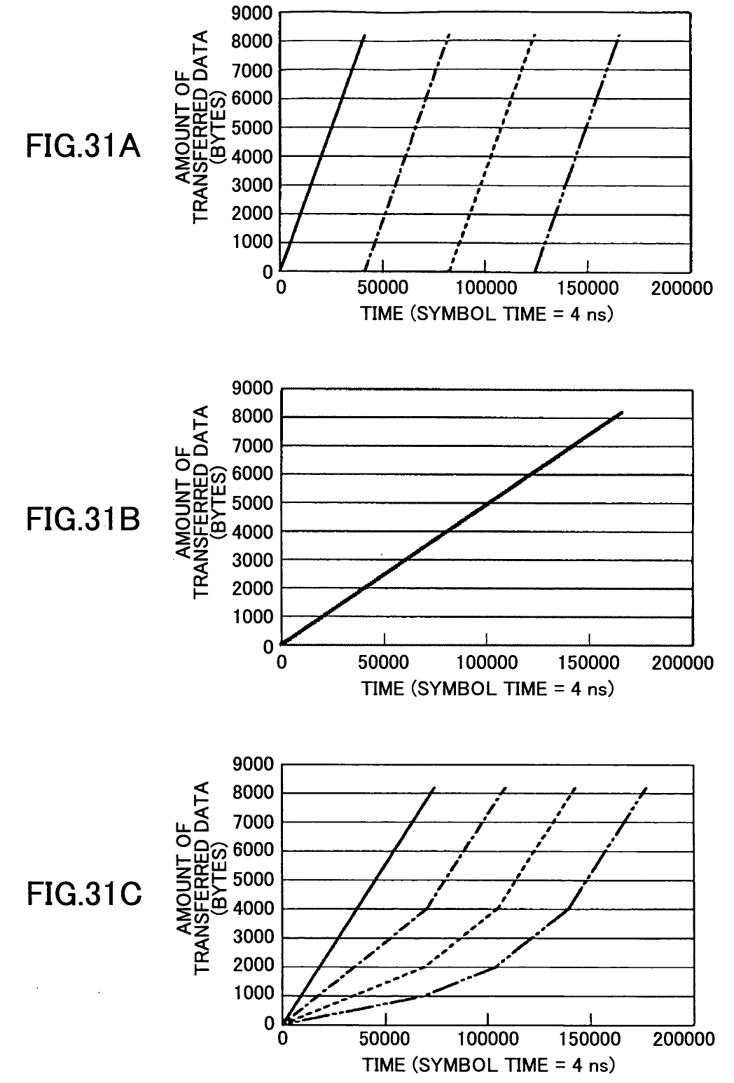

A brief description will now be given of the basic characteristic of each of the algorithms described above, including the strict algorithm, when carrying out 4 kinds of data transfers of the TCs TC0 through TC3, by referring to FIGS. 31A through 31C. FIGS. 31A through 31C are diagrams showing an arbitration characteristic. The measurement of the arbitration characteristic needs to observe the dynamic changes, and thus, FIGS. 31A through 31C show the arbitration characteristic as a data cumulative diagram. In FIGS. 31A through 31C, the ordinate indicates the amount of transferred data (cumulative value), and the abscissa indicates the time. It is assumed that the measurements for the 4 kinds of payload sizes were made under a condition of 128 bytes, and that the cumulative value of each amount of data is approximately 8000 bytes.

FIG. 31A shows the strict characteristic, and the algorithm simply flows the data in sequence. FIG. 31B shows the Round Robin (RR) characteristic, and the algorithm flows the 4 kinds of data in sequence and in equal divisions. FIG. 31C shows the Weighted Round Robin (WRR) characteristic, and the algorithm flows the 4 kinds of data while changing proportions. FIG. 31C shows a case where the algorithm transfers the 4 kinds of data at a proportion of 1:2:4:8, and when the data transfer of one TC ends, the data transfer is made for the remaining TCs at a changed proportion of 8:4:2, then at a changed proportion of 8:4, etc. so that the data transfer is made while changing the proportion. The Time Base Weighted Round Robin (TBWRR) includes the management of the concept of time to the WRR.

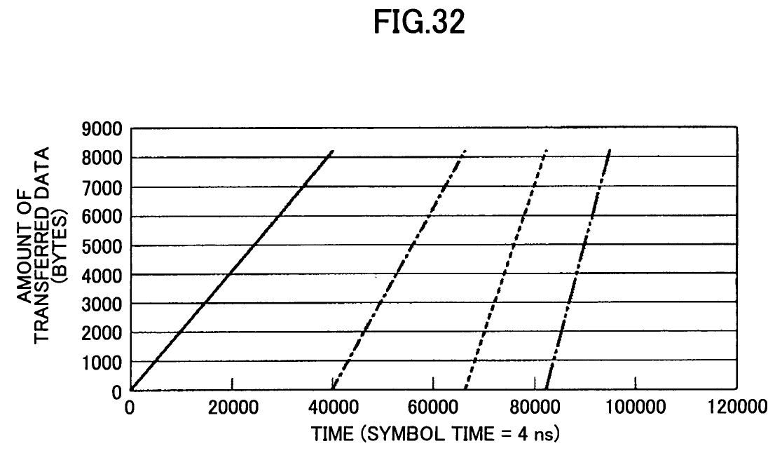

FIG. 32 is a diagram showing a basic characteristic of the payload when measured by the strict algorithm. In FIG. 32, the ordinate indicates the amount of transferred data (cumulative value), and the abscissa indicates the time. It may be seen from FIG. 32 that the transfer rate becomes lower as the payload becomes smaller, and that the transfer rate becomes higher as the payload becomes larger. Such a payload characteristic is similarly obtained when the other arbitration algorithms are employed. Particularly in the case of the WRR algorithm, it is effective to take into consideration the payload size in order to determine the transfer rate depending on the proportion.

Suppose that the switch 8 in conformance with the PCI Express standard is provided in the route of the high-speed serial bus 7, the image input part 3 and the image output part 4 are connected to the printer controller 6 via different ports of the switch 8, and the two transactions in which the image data are transferred from the image input part to the printer controller 6 in synchronism with the line synchronizing signal and the image data are transferred from the printer controller 6 to the image output part 4 in synchronism with the line synchronizing signal, via the high-speed serial bus 7 are allocated to different TCs. In this case, it may be seen from FIG. 30 that it is desirable to employ the mechanism which sets the strict priority of the VC arbitration 9c of the output port E of the switch 8, so that the image data transfer from the printer controller 6 to the image output part 4 is carried out with priority over the image data transfer from the image input part 3 to the printer controller 6.

On the other hand, the data transfer system that is applicable to any of the structures shown in FIGS. 17, 18, 19 and 22 through 26 in which the data transfer is possible from the image processing part 5 directly to the printer controller 6 integrally comprising the storage part 9 and the data transfer is possible from the printer controller 6 directly to the image output part 4, basically transfers the image data from the image processing part 5 to the printer controller 6 in synchronism with the line synchronizing signal and transfers the image data from the printer controller 6 to the image output part 4 in synchronism with the line synchronizing signal, via the high-speed serial bus 7. In this case, it is preferable to employ the data transfer system which carries out the data transfer from the printer controller 6 to the image output part 4 with priority over the data transfer from the image processing part 5 to the printer controller 6.

More particularly, in one embodiment of the present invention, the data transfer system uses the image processing part 5 and the image output part 4 as the initiators of the image data transfer, and the memory write transaction is used in the image processing part 5 while the memory read transaction is used in the image output part 4. Moreover, the memory write transaction and the memory read transaction are allocated to different TCs. When setting the VC, the priority of the TC of the memory read transaction in the image output part 4 is set higher than the priority of the TC of the memory write transaction in the image processing part 5, and the strict priority is set so that the memory write transaction is issued after the entire the memory read transaction is issued. As a result, it becomes possible to output the image data at a high speed even if timing restrictions of the line synchronous transfer exist, and a plurality of image data transfers can be carried out simultaneously.

In this case, it is also possible to apply the command issuing sequence shown in FIG. 29B.

In the description given heretofore, the present invention is applied to an image forming system in which only one serial communication control part 2 is provided in the system. However, the present invention is of course similarly applicable to image forming systems in which a plurality of serial communication control parts are provided. In this case, a dynamic arbitration of the plurality of serial communication control parts is carried out when the image forming system is operated, so that only one of the serial communication control parts operates as an effective serial communication control part.

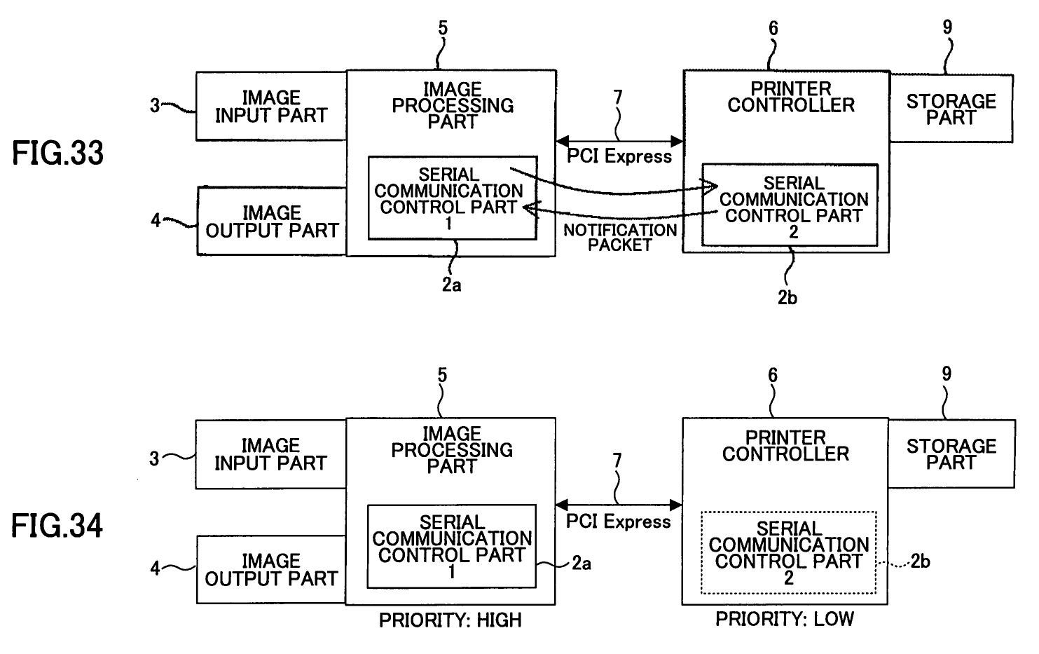

FIG. 33 is a system block diagram generally showing a structure of the image forming system having a plurality of serial communication control parts in a state before a link-up, and FIG. 34 is a system block diagram generally showing a structure of the image forming system shown in FIG. 33 in a state after the link-up.

In the state before the link-up, it is assumed that 2 serial communication control parts 2a and 2b exist within the image forming system as shown in FIG. 33. In the image forming system having such a system structure, the serial communication control parts 2a and 2b mutually output packets (notification packets) notifying the entire image forming system of their existence, immediately after the link-up. Each of the serial communication control parts 2b and 2a that receives the notification packet compares the priority order indicated in the received notification packet and the priority order of itself, judges that it is the effective serial communication control part 2 within the image forming system only if the priority order of itself is higher according to the priority orders predefined by a system designer, and otherwise selects not to operate as the effective serial communication control part 2 within the image forming system.

FIG. 34 shows the state after the link-up for a case where the priority order of the serial communication control part 2a is higher than that of the serial communication control part 2b, the serial communication control part 2a becomes the effective serial communication control part 2 within the image forming system, and the serial communication control part 2b does not operate as indicated by phantom lines.

The control to use one of the serial communication control parts 2a and 2b as the effective serial communication control part 2 within the image forming system as described above may easily be carried out by using the message packets according to the PCI Express standard.

In the described embodiments, only one each is provided with regard to the image input part 3, the image output part 4, the image processing part 5, the storage part 9 and the printer controller 6. However, each of these constituent elements may simultaneously exist in a plurality of numbers.

This application claims the benefit of Japanese Patent Applications No.2004-142084 filed May 12, 2004 and No.2004-324554 filed Nov. 9, 2004, in the Japanese Patent Office, the disclosure of which is hereby incorporated by reference.

Further, the present invention is not limited to these embodiments, but various variations and modifications may be made without departing from the scope of the present invention.

1. An image forming system comprising:
a serial communication control part, an image input part, an image output part, an image processing part, a storage part and a printer controller; and
a high-speed serial bus mutually coupling the serial communication control part and at least one of the image input part, the image output part, the image processing part, the storage part and the printer controller.

2. The image forming system as claimed in claim 1, wherein the high-speed serial bus couples the image processing part and the printer controller which includes the serial communication control part.

3. The image forming system as claimed in claim 1, wherein the high-speed serial bus couples the printer controller and the image processing part which includes the serial communication control part.

4. The image forming system as claimed in claim 1, wherein the high-speed serial bus couples the serial communication control part and each of the image input part, the image output part, the image processing part, the storage part and the printer controller.

5. The image forming system as claimed in claim 1, wherein the high-speed serial bus couples the printer controller which includes the serial communication control part, and each of the image input part, the image output part, the image processing part and the storage part.

6. The image forming system as claimed in claim 1, wherein the high-speed serial bus couples the image input part which includes the serial communication control part, and each of the printer controller, the image output part, the image processing part and the storage part.

7. The image forming system as claimed in claim 1, wherein the high-speed serial bus couples the image processing part which includes the serial communication control part, and each of the image input part, the image output part, the printer controller and the storage part.

8. The image forming system as claimed in claim 1, wherein the high-speed serial bus couples the image output part which includes the serial communication control part, and each of the image input part, the printer controller, the image processing part and the storage part.

9. The image forming system as claimed in claim 1, further comprising:
a packet switch provided in a route of the high-speed serial bus.

10. The image forming system as claimed in claim 9, wherein at least the image output part and the storage part are coupled near each other via the high-speed serial bus and at least one stage of the packet switch.

11. The image forming system as claimed in claim 1, wherein image data are transferred from the image input part to the printer controller in synchronism with a line synchronizing signal, and image data are transferred from the printer controller to the image output part in synchronism with the line synchronizing signal, via the high-speed serial bus.

12. The image forming system as claimed in claim 11, wherein the transfer of the image data from the printer controller to the image output part has a priority over the transfer of the image data from the image input part to the printer controller.

13. The image forming system as claimed in claim 11, wherein the image data are transferred according to a data transfer system which uses a memory write transaction in the image input part and uses a memory read transaction in the image output part, so that the image input part and the image output part become initiators of the image data transfer.

14. The image forming system as claimed in claim 13, wherein the memory write transaction and the memory read transaction are allocated to different traffic classes.

15. The image forming system as claimed in claim 14, wherein a virtual channel is set so that a priority of the traffic class of the memory read transaction used in the image output part is higher than a priority of the traffic class of the memory write transaction used in the image input part.

16. The image forming system as claimed in claim 15, wherein a strict priority is set so that the memory write transaction is issued after the entire memory read transaction is issued.

17. The image forming system as claimed in claim 1, wherein image data are transferred from the image processing part to the printer controller in synchronism with a line synchronizing signal, and image data are transferred from the printer controller to the image processing part in synchronism with the line synchronizing signal, via the high-speed serial bus.

18. The image forming system as claimed in claim 17, the transfer of the image data from the printer controller to the image output part has a priority over the transfer of the image data from the image processing part to the printer controller.

19. The image forming system as claimed in claim 17, wherein the image data are transferred according to a data transfer system which uses a memory write transaction in the image processing part and uses a memory read transaction in the image output part, so that the image processing part and the image output part become initiators of the image data transfer.

20. The image forming system as claimed in claim 19, wherein the memory write transaction and the memory read transaction are allocated to different traffic classes.

21. The image forming system as claimed in claim 20, wherein a virtual channel is set so that a priority of the traffic class of the memory read transaction used in the image output part is higher than a priority of the traffic class of the memory write transaction used in the image processing part.

22. The image forming system as claimed in claim 21, wherein a strict priority is set so that the memory write transaction is issued after the entire memory read transaction is issued.

23. The image forming system as claimed in claim 1, further comprising:
a packet switch provided in a route of the high-speed serial bus,
wherein:
the image input part, the image output part and the printer controller are coupled to mutually different ports of the packet switch,
the same traffic class is allocated to two transactions in which image data are transferred from the image input part to the printer controller in synchronism with a line synchronizing signal, and image data are transferred from the printer controller to the image output part in synchronism with the line synchronizing signal, via the high-speed serial bus, and
the transfer of the image data from the printer controller to the image output part has a priority over the transfer of the image data from the image input part to the printer controller, by a port arbitration carried out in the packet switch.

24. The image forming system as claimed in claim 23, wherein the port arbitration carried out in the packet switch employs a Round Robin (RR).

25. The image forming system as claimed in claim 23, wherein the port arbitration carried out in the packet switch employs a Weighted Round Robin (WRR).

26. The image forming system as claimed in claim 23, wherein the port arbitration carried out in the packet switch employs a Time Base Weighted Round Robin (TBWRR).

27. The image forming system as claimed in claim 1, further comprising:
a packet switch provided in a route of the high-speed serial bus,
wherein:
the image input part, the image output part and the printer controller are coupled to mutually different ports of the packet switch,
mutually different traffic classes are allocated to two transactions in which image data are transferred from the image input part to the printer controller in synchronism with a line synchronizing signal, and image data are transferred from the printer controller to the image output part in synchronism with the line synchronizing signal, via the high-speed serial bus, and
the transfer of the image data from the printer controller to the image output part has a priority over the transfer of the image data from the image input part to the printer controller, by a virtual channel arbitration carried out in an output port of the packet switch.

28. The image forming system as claimed in claim 1, wherein communication channels that are independent for transmission and reception in point-to-point of a data communication network having a tree structure are established in the high-speed serial bus.

29. The image forming system as claimed in claim 28, wherein the high-speed serial bus comprises a high-speed serial bus in conformance with a PCI Express standard.
